(19) United States
(12) Patent Application Publication
(10) Pub. No.: US 2022/0300147 A1
(43) Pub. Date: Sep. 22, 2022

(54) DISPLAY APPARATUS, DISPLAY METHOD, AND NON-TRANSITORY RECORDING MEDIUM

(71) Applicant: Kota NAGAOKA, Kanagawa (JP)

(72) Inventor: Kota NAGAOKA, Kanagawa (JP)

(21) Appl. No.: 17/670,525

(22) Filed: Feb. 14, 2022

(30) Foreign Application Priority Data
Mar. 17, 2021 (JP) 2021-044059

(51) Int. Cl. G06F 3/04842; G06F 3/04817; G06F 3/0488; G06F 3/0482

(52) U.S. Cl. CPC G06F 3/04842; G06F 3/04817; G06F 3/0488; G06F 3/0482

(57) ABSTRACT

A display apparatus includes circuitry to display, on a display, a plurality of objects including a first object and a second object. One or more of the plurality of objects reflects handwriting input. The circuitry receives a first selection of the first object. The circuitry receives a second selection of the second object. The circuitry sets a link between the first object and the second object to associate the first object and the second object with each other.

### CROSS-REFERENCE TO RELATED APPLICATION

This patent application is based on and claims priority pursuant to 35 U.S.C. § 119(a) to Japanese Patent Application No. 2021-044059, filed on Mar. 17, 2021, in the Japan Patent Office, the entire disclosure of which is hereby incorporated by reference.

### BACKGROUND

### Technical Field

Embodiments of the present disclosure relate to a display apparatus, a display method, and a non-transitory recording medium.

### Related Art

Display apparatuses that convert handwritten data into text and displays the text on a display by using a handwriting recognition technique are known. A display apparatus having a relatively large touch panel is used in a conference room, and is shared by a plurality of users as an electronic whiteboard, for example.

In such a display apparatus, a page may have an extremely large size. On such a page having an extremely large size, when handwriting is input, an area where one or more descriptions, which may be referred to as objects, related to the handwriting may be away from a position where the handwriting is input. In addition, there is a case where a user fails to find a page that is previously saved and includes a description related to the handwriting currently being input.

To cope with such cases as described above, a technique for automatically extracting and displaying descriptions related to handwriting currently input has been proposed. When an object is selected from a file or handwritten information according to a user operation, a known display apparatus automatically specifies one or more objects related to the selected object in the file or the handwritten information as a specified object group, and displays the selected object along with the specified object group to be referred.

### SUMMARY

An embodiment of the present disclosure includes a display apparatus including circuitry to display, on a display, a plurality of objects including a first object and a second object. One or more of the plurality of objects reflects handwriting input. The circuitry receives a first selection of the first object. The circuitry receives a second selection of the second object. The circuitry sets a link between the first object and the second object to associate the first object and the second object with each other.

An embodiment of the present disclosure includes a display method including displaying, on a display, a plurality of objects including a first object and a second object. One or more of the plurality of objects reflects handwriting input. The method includes receiving a first selection of the first object. The method includes receiving a second selection of the second object. The method includes setting a link between the first object and the second object to associate the first object and the second object with each other.

An exemplary embodiment of the present disclosure includes a non-transitory recording medium storing a plurality of instructions which, when executed by one or more processors, causes the processors to perform a method including displaying, on a display, a plurality of objects including a first object and a second object. One or more of the plurality of objects reflects handwriting input. The method includes receiving a first selection of the first object. The method includes receiving a second selection of the second object. The method includes setting a link between the first object and the second object to associate the first object and the second object with each other.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a screen displaying a display range corresponding to a part of a page of which a size is extremely large, according to a comparative example of a first embodiment of the present disclosure:

FIG. 2 is a diagram illustrating the entire page of FIG. 1;

FIG. 3 is a diagram illustrating a screen with respect to which each object is associated with another object or other objects, according to the first embodiment of the present disclosure:

FIG. 4 is a diagram illustrating a screen displaying a display range including an associated object, according to the first embodiment of the present disclosure;

FIG. 5 is a diagram illustrating a screen with respect to which an object is associated with another object that is a page, according to the first embodiment of the present disclosure:

FIG. 6 is a diagram illustrating a screen with respect to which an object is associated with another object that is a page, according to the first embodiment of the present disclosure;

FIG. 7 is a diagram illustrating a screen displaying a display range corresponding to an associated page, according to the first embodiment of the present disclosure:

FIG. 8A to FIG. 8C are diagrams each illustrating an overall configuration of a display apparatus, according to the first embodiment of the present disclosure;

FIG. 9 is a block diagram illustrating a hardware configuration of the display apparatus according to the first embodiment of the present disclosure:

FIG. 10 is a block diagram illustrating a functional configuration of the display apparatus according to the first embodiment of the present disclosure:

FIG. 11 is a diagram illustrating all objects included in an entire page, according to the first embodiment of the present disclosure;

FIG. 12 is a diagram illustrating a first example of a screen displayed by the display apparatus according to the first embodiment of the present disclosure;

FIG. 13 is a diagram illustrating a second example of a screen displayed by the display apparatus according to the first embodiment of the present disclosure;

FIG. 14 is a diagram illustrating a third example of a screen displayed by the display apparatus according to the first embodiment of the present disclosure:

FIG. 15 is a diagram illustrating a fourth example of a screen displayed by the display apparatus according to the first embodiment of the present disclosure:

FIG. 16 is a diagram illustrating a fifth example of a screen displayed by the display apparatus according to the first embodiment of the present disclosure;

FIG. 17 is a diagram illustrating a table used to specify a link source object, according to the first embodiment of the present disclosure:

FIG. 18 is a diagram illustrating a table used to specify a link destination object, according to the first embodiment of the present disclosure:

FIG. 19 is a diagram illustrating a table used to add a record to a link storage unit, according to the first embodiment of the present disclosure;

FIG. 20 is a sequence diagram illustrating a process of setting a link between two objects to be associated with each other, performed by the display apparatus according to the first embodiment of the present disclosure;

FIG. 21 is a diagram illustrating a screen on which a link source object is being selected, according to the first embodiment of the present disclosure:

FIG. 22 is a diagram illustrating a screen displaying a display range including the link destination object, according to the first embodiment of the present disclosure:

FIG. 23 is a diagram illustrating a table used to search for a link source object in an object storage unit, according to the first embodiment of the present disclosure;

FIG. 24 is a diagram illustrating a table used to search for the link source object in the link storage unit, according to the first embodiment of the present disclosure;

FIG. 25 is a diagram illustrating a table used to search for a link destination object in the object storage unit, according to the first embodiment of the present disclosure;

FIG. 26 is a sequence diagram illustrating a process, performed by the display apparatus, of displaying a link destination object based on link information in response to a user operation of pressing a corresponding link source object, according to the first embodiment of the present disclosure;

FIG. 27 is a diagram illustrating a screen on which stroke data representing a stroke is being input by handwriting of a user to select an area, according to a second embodiment of the present disclosure:

FIG. 28 is a diagram illustrating a table used to set an area as a link destination in a link storage unit, according to the second embodiment of the present disclosure;

FIG. 29 is a sequence diagram illustrating a process of setting a link between an object and an area to be associated with each other, performed by a display apparatus according to the second embodiment of the present disclosure;

FIG. 30 is a flowchart illustrating a process of determining a display scale factor, performed by a display control unit according to a third embodiment of the present disclosure:

FIG. 31 is a diagram illustrating a screen displaying a display range having been enlarged and on which a link source object is being selected, according to the third embodiment of the present disclosure;

FIG. 32 is a diagram illustrating a link destination object being displayed with a current display scale factor on a screen, according to the third embodiment of the present disclosure;

FIG. 33 is a diagram illustrating a screen after changing a setting of display scale factor, according to the third embodiment of the present disclosure;

FIG. 34A is a diagram illustrating a screen on which a link destination object is displayed on a center of a screen of a display, according to a fourth embodiment of the present disclosure;

FIG. 34B is a diagram illustrating a screen on which the link destination object is displayed on an upper left of a screen of the display, according to the fourth embodiment of the present disclosure:

FIG. 35 is a flowchart illustrating a process of determining a display position of a link destination object or a link destination area by a link specifying unit according to the fourth embodiment of the present disclosure;

FIG. 36 is a diagram illustrating an object list to be displayed by a display control unit according to a fifth embodiment of the present disclosure;

FIG. 37 is a sequence diagram illustrating a process of setting a link between two objects to be associated with each other, performed by a display apparatus according to the fifth embodiment of the present disclosure;

FIG. 38 is a diagram illustrating a screen on which a link source object is being selected, according to a sixth embodiment of the present disclosure:

FIG. 39 is a diagram illustrating a screen including an example of a sub-view that includes a link destination object associated with the link source object selected in FIG. 38;

FIG. 40 is a diagram illustrating a screen on which a link source object is being selected according to a user operation, according to the sixth embodiment of the present disclosure;

FIG. 41 is a diagram illustrating a screen including a sub-view a link destination object associated with the link source object selected in FIG. 40;

FIG. 42 is a sequence diagram illustrating a sequence diagram illustrating a process of displaying a sub-view, according to the sixth embodiment of the present disclosure;

FIG. 43 is a diagram illustrating a screen on which a reservation for a link destination is being made, according to a seventh embodiment of the present disclosure:

FIG. 44 is a diagram illustrating a screen displaying association of two objects by using reservations for a link destination, according to the seventh embodiment of the present disclosure;

FIG. 45 is a sequence diagram illustrating a process of setting a link between two objects to be associated with each other by using a reserved object, according to the seventh embodiment of the present disclosure;

FIG. 46 is a diagram illustrating a screen on which a link source object is being selected according to a user operation, according to an eighth embodiment of the present disclosure;

FIG. 47 is a diagram illustrating a screen on which thumbnails of link destination objects are displayed, according to the eighth embodiment of the present disclosure;

FIG. 48 is a diagram illustrating a screen displaying a display range when one of the link destination objects in FIG. 47 is selected, according to the eighth embodiment of the present disclosure;

FIG. 49 is a sequence diagram illustrating a process, performed by a display apparatus, of displaying a link destination object that is selected according to a user operation from among a plurality of link destination objects displayed as thumbnails, according to the eighth embodiment of the present disclosure:

FIG. 50 is a diagram illustrating a table of time-series object list stored in a display control unit, according to a ninth embodiment of the present disclosure;

FIG. 51 is a diagram illustrating a screen on which an icon corresponding to a preview function is displayed, according to the ninth embodiment of the present disclosure:

FIG. 52 is a diagram illustrating a screen including a link destination object displayed by a display apparatus according to the ninth embodiment of the present disclosure:

FIG. 53 is a diagram illustrating a screen that is displayed in response to a preview button being pressed, according to the ninth embodiment of the present disclosure:

FIG. 54 is a flowchart illustrating a process of displaying a link destination object according to a user operation of selecting the preview function or a next view function, performed by the display apparatus according to the ninth embodiment of the present disclosure:

FIG. 55 is a diagram illustrating a configuration of a display system according to a tenth embodiment of the present disclosure:

FIG. 56 is a diagram illustrating a configuration of a display system according to an eleventh embodiment of the present disclosure;

FIG. 57 is a diagram illustrating a configuration of a display system according to a twelfth embodiment of the present disclosure; and

FIG. 58 is a diagram illustrating a configuration of a display system according to a thirteenth embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A description is given below of a display apparatus and a display method performed by the display apparatus according to embodiments of the present disclosure, with reference to the attached drawings.

### First Embodiment

### COMPARATIVE EXAMPLE

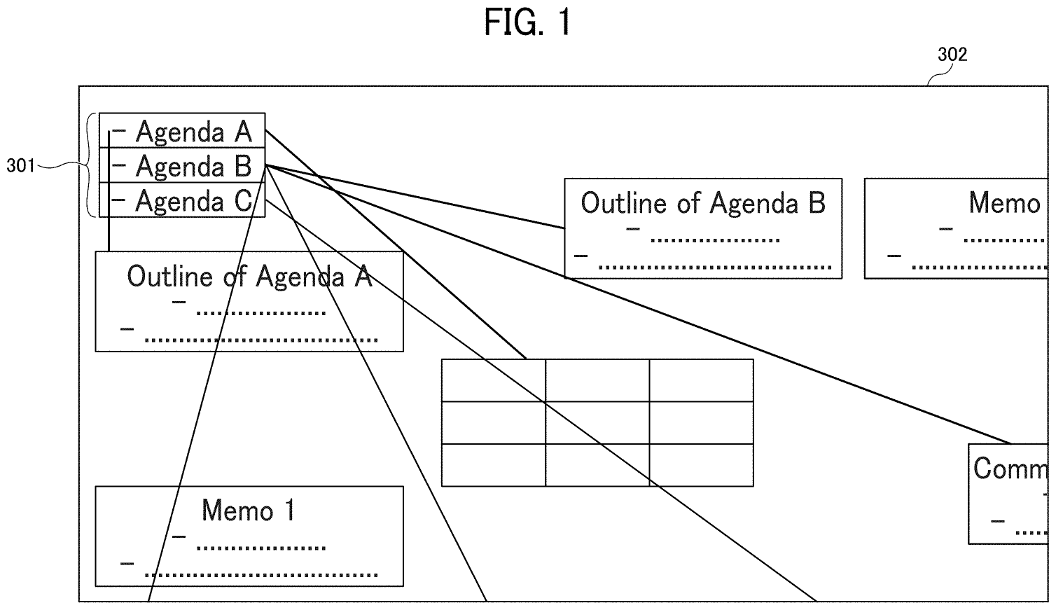

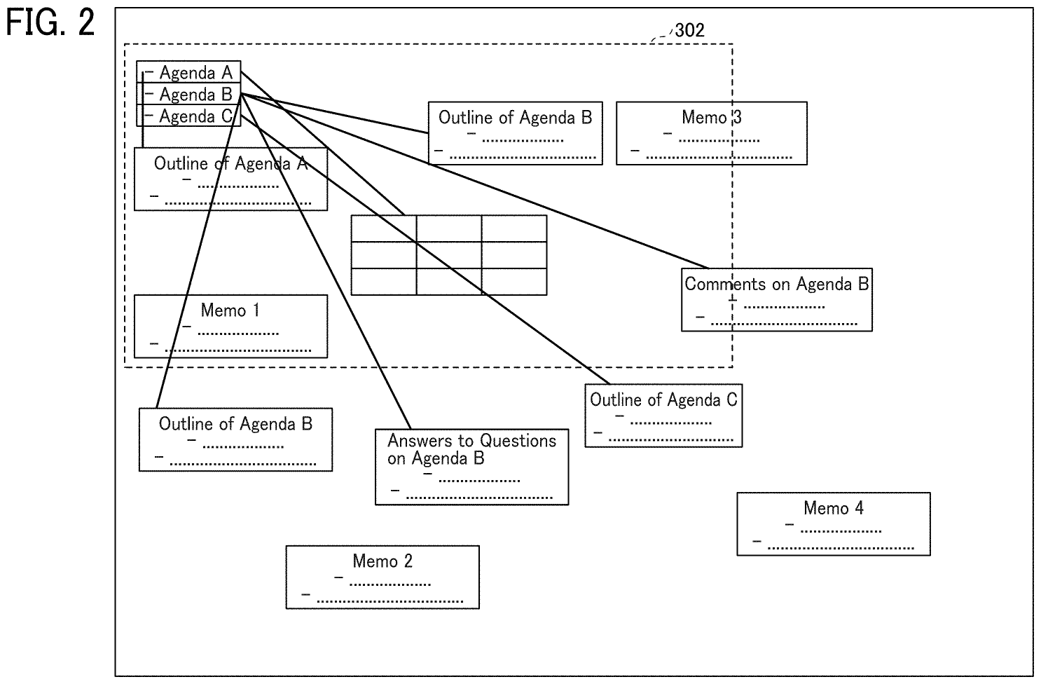

A description is given below of a comparative example for explaining a display apparatus according to the present embodiment, with reference to FIG. 1 and FIG. 2. FIG. 1 is a diagram illustrating a screen displaying a display range corresponding to a part of a page (a single page) of which a size is extremely large, according to a comparative example of a first embodiment of the present disclosure. The size of the page varies without limitation according to page content and thus may become an extremely large. FIG. 2 is a diagram illustrating the entire page of FIG. 1. A dotted line in FIG. 2 indicates a display range 302 corresponding to the display range of FIG. 1.

On the page illustrated in FIG. 1 and FIG. 2, three objects 301, “Agenda A,” “Agenda B.” and “Agenda C” are displayed at an upper left of the page, and each of the objects 301, “Agenda A,” “Agenda B.” and “Agenda C,” is associated with one or more corresponding other objects by one or more lines. Even when different colors are used for plural lines indicating associations each of which is an association between two or more objects, the plural lines intersect one another, resulting in difficulty to see the associations between the objects.

Overview of Display Apparatus:

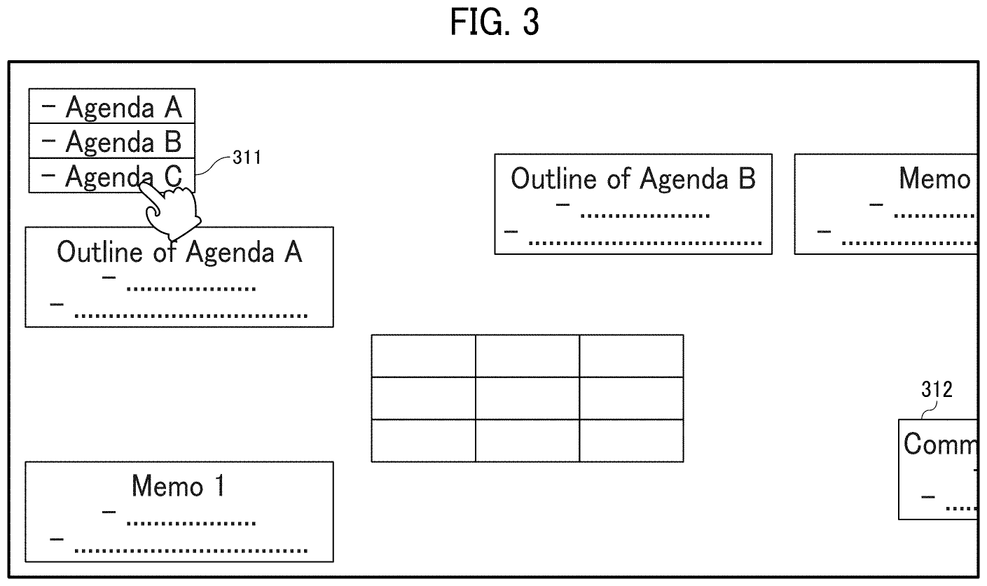

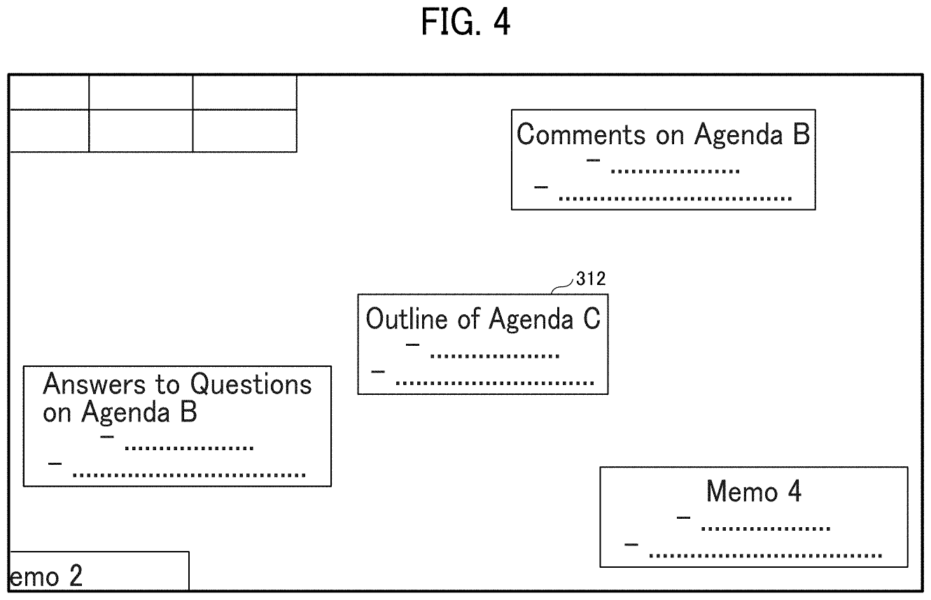

A description is given below of an overview of the display apparatus according to the present embodiment, with reference to FIG. 3 and FIG. 4. FIG. 3 is a diagram illustrating a screen with respect to which each object is associated with another object or other objects, according to the present embodiment. A range of the screen illustrated in FIG. 3 is corresponding to the display range 302 indicated in FIG. 2. In FIG. 3, an object 311 of “Agenda C” at an upper left is associated with an object 312 of “Outline of Agenda C,” of which apart is displayed on at a lower right of the screen. A detailed description of this is given later.

When the object 311 of “Agenda C” is selected according to a user operation as illustrated in FIG. 3, the display apparatus specifies the object 312 of “Outline of Agenda C,” which is associated with the object 311 of “Agenda C.” Then, as illustrated in FIG. 4, the display apparatus displays the object 312 of “Outline of Agenda C” at, for example, the center of the display.

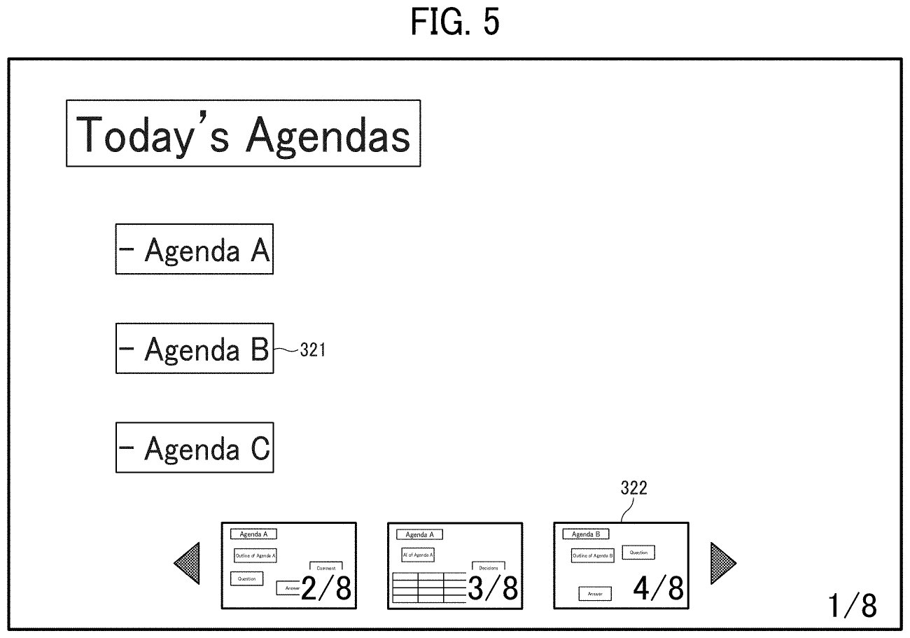

In the present embodiment, pages are also regarded as objects. FIG. 5 to FIG. 7 are diagrams each illustrating a screen with respect to which an object is associated with another object that is a page, according to the present embodiment. In FIG. 5, an object 321 of “Agenda B” at an upper left is associated with an object 322 that is a page at a lower portion.

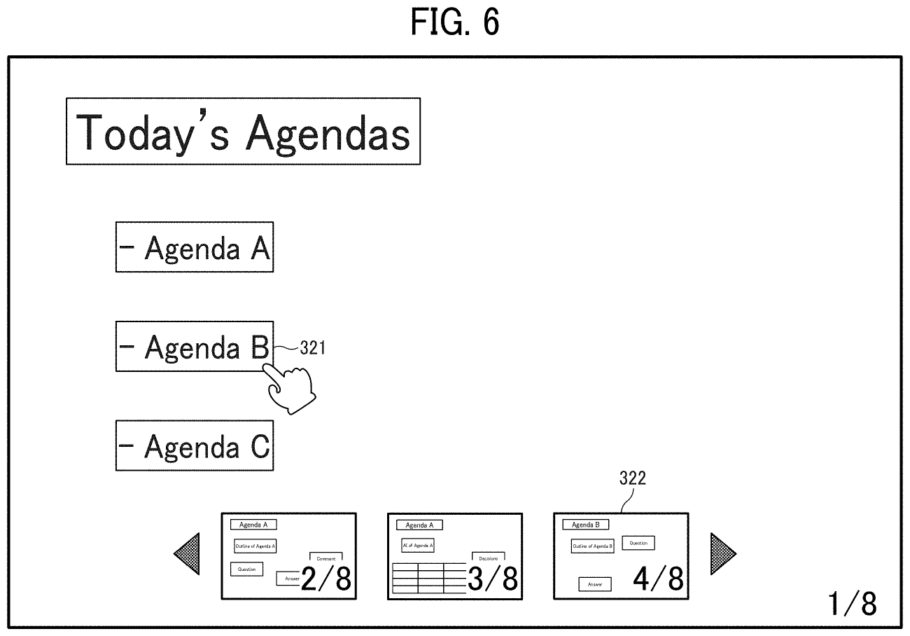

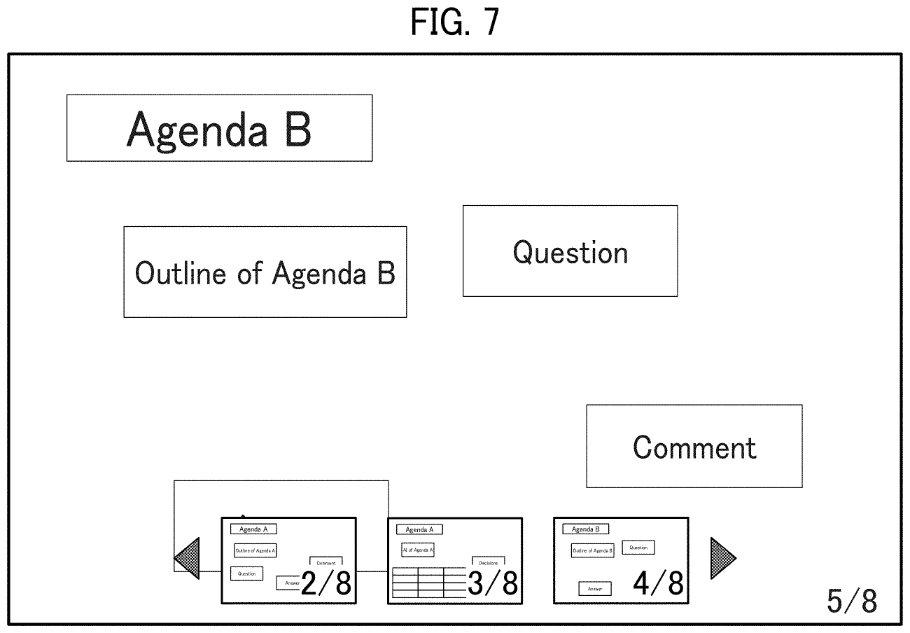

When the object 321 of “Agenda B” is selected according to a user operation as illustrated in FIG. 6, the display apparatus specifies the object 322, which is a page and associated with the object 321 of “Agenda B.” Then, as illustrated in FIG. 7, the display apparatus displays the page corresponding to the object 322 on a display.

As described above, with the display apparatus according to the present embodiment, the user does not need to remember the associations between the objects or to search for a certain object associated with a corresponding object for displaying the certain object. The display apparatus according to the present embodiment also allows the user to view information surrounding the certain object, which is associated with the corresponding object.

### Terms

“Input device” may be any devices with each of which handwriting by designating coordinates on a touch panel is performable. Examples thereof include a pen, a human finger, a human hand, and a bar-shaped member.

A series of user operations including engaging a writing mode, recording movement of an input device or portion of a user, and then disengaging the writing mode is referred to as a stroke. The engaging of the writing mode may include, if desired, pressing an input device against a display or screen, and disengaging the writing mode may include releasing the input device from the display or screen. Alternatively, a stroke includes tracking movement of the portion of the user without contacting a display or screen. In this case, the writing mode may be engaged or turned on by a gesture of a user, pressing a button by a hand or a foot of the user, or otherwise turning on the writing mode, for example using a pointing device such as a mouse. The disengaging of the writing mode can be accomplished by the same or different gesture used to engage the writing mode, releasing the button, or otherwise turning off the writing mode, for example using the pointing device or mouse. “Stroke data” is data based on a trajectory of coordinates of a stroke input with the input device, and the coordinates may be interpolated appropriately. “Handwritten data” is data having one or more stroke data, namely including stroke data corresponding to one or more strokes. “Handwriting input” represents input of handwritten data according to a user operation.

An “object” refers to an item displayed on a screen. The term “object” in this specification represents an object of display. Examples of “object” include items displayed based on stroke data, objects obtained by handwriting recognition from stroke data, graphics, images, characters, and the like.

“Determined data” includes data that is obtained by conversion into a character code (font) by character recognition performed on handwritten data and being selected by a user. In addition, the determined data includes handwritten data that is determined not to be converted into a character code (font).

“Operation command” refers to a command for instructing execution of a specific process prepared for operating a handwriting input device. For example, processing of editing, modifying, or inputting/outputting is performable on a character string with the operation command.

The character string includes one or more characters handled by a computer. The character string actually is one or more character codes. Characters include numbers, alphabets, symbols, and the like. The character string is also referred to as text data.

Association means that two or more things are related to each other. Associating refers to linking two or more items in, for example, a database so as to be related.

Configuration of Apparatus:

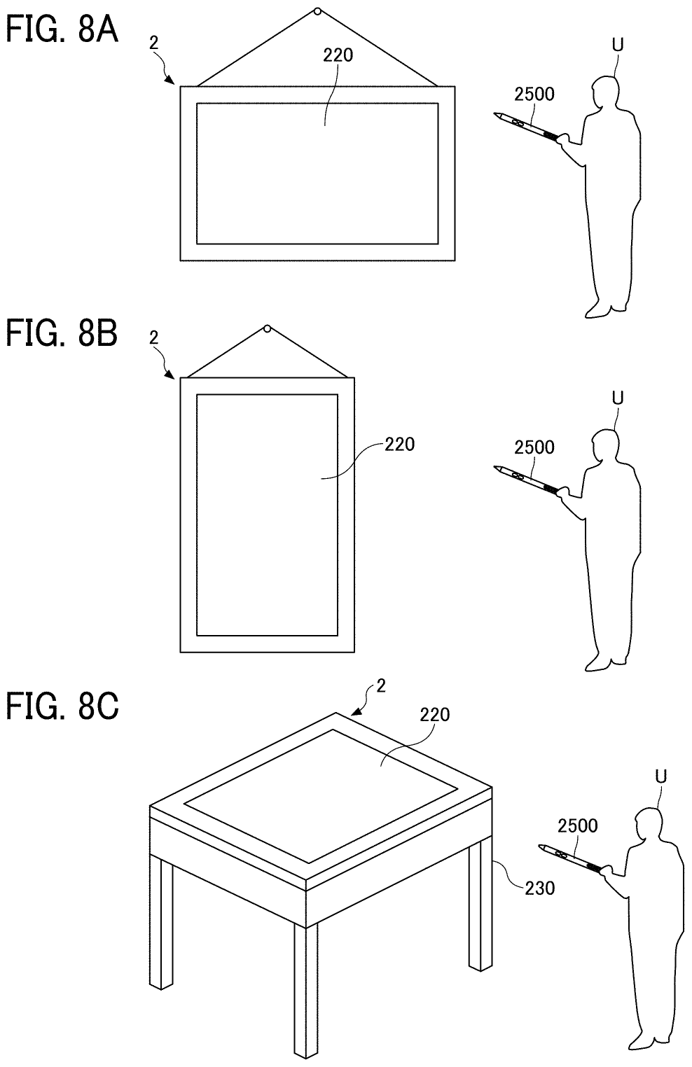

An overall configuration of a display apparatus 2 according to the present embodiment is described with reference to FIG. 8A to FIG. 8C. FIG. 8A to FIG. 8C are diagrams each illustrating an overall configuration of the display apparatus 2, according to the present embodiment. FIG. 8A illustrates, as an example of the display apparatus 2, the display apparatus 2 used as an electronic whiteboard having a landscape rectangular shape and being hung on a wall.

As illustrated in FIG. 8A, a display 220 as an example of a display device is provided to the display apparatus 2. A user performs handwriting (inputs, draws) characters or the like on the display 220 using a pen 2500.

FIG. 8B illustrates the display apparatus 2 used as an electronic whiteboard having a portrait rectangular shape and being hung on a wall.

FIG. 8C illustrates the display apparatus 2 placed on the top of a desk 230. Since the display apparatus 2 has a thickness of about 1 centimeter, the desk 230 does not need to be adjusted when the display apparatus 2 is placed on the top of the desk 230, which is a general-purpose desk. In addition, the display apparatus 2 is movable by users without difficulty.

Examples of an input method of coordinates by the pen 2500 include an electromagnetic induction method and an active electrostatic coupling method. In other example, the pen 2500 further has functions such as pen pressure detection, inclination detection, a hover function (displaying a cursor before the pen is brought into contact), or the like.

Hardware Configuration:

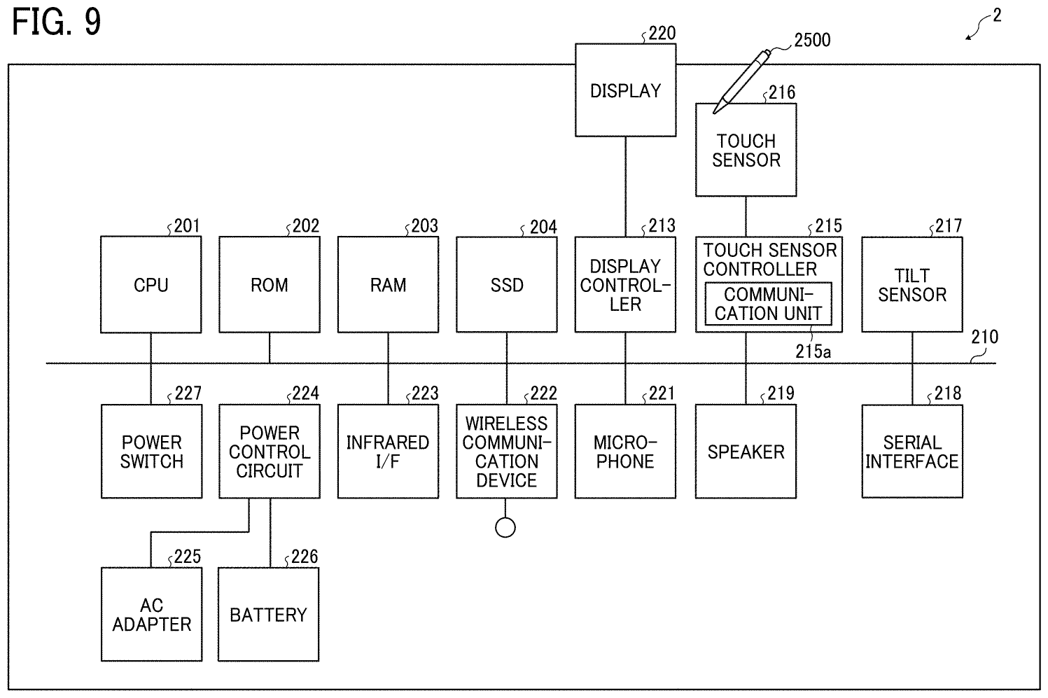

A description is given below of a hardware configuration of the display apparatus 2 according to the present embodiment, with reference to FIG. 9. The display device 2 has a configuration of an information processing apparatus or a computer as illustrated in FIG. 9. FIG. 9 is a block diagram illustrating a hardware configuration of the display apparatus 2 according to the present embodiment. As illustrated in FIG. 9, the display apparatus 2 includes a central processing unit (CPU) 201, a read only memory (ROM) 202, a random access memory (RAM) 203, and a solid state drive (SSD) 204.

The CPU 201 controls entire operation of the display apparatus 2. The ROM 202 stores a control program such as an initial program loader (IPL) to boot the CPU 201. The RAM 203 is used as a work area for the CPU 201.

The SSD 204 stores various data such as an operating system (OS) and a control program for display apparatuses. This program may be an application program that runs on an information processing apparatus equipped with a general-purpose operating system (OS) such as WINDOWS, MAC OS, ANDROID, and IOS.

The display apparatus 2 further includes a display controller 213, a touch sensor controller 215, a touch sensor 216, a display 220, a power switch 227, a tilt sensor 217, a serial interface 218, a speaker 219, a microphone 221, a wireless communication device 222, an infrared interface (I/F) 223, a power control circuit 224, an AC adapter 225, and a battery 226.

The display controller 213 controls display of an image for output to the display 220, etc. The touch sensor 216 detects that the pen 2500, a user's hand or the like is brought into contact with the display 220. The pen or the user's hand is an example of input means. The touch sensor 216 also receives a pen identifier (ID).

The touch sensor controller 215 controls processing of the touch sensor 216. The touch sensor 216 performs coordinate input and coordinate detection. More specifically, in a case where the touch sensor 216 is optical type, the display 220 is provided with two light receivers/emitters disposed on both upper side ends of the display 220, and a reflector frame surrounding the sides of the display 220. The light receivers/emitters emit a plurality of infrared rays in parallel to a surface of the display 220. Light receiving elements receive lights passing in the direction that is the same as an optical path of the emitted infrared rays, which are reflected by the reflector frame. The touch sensor 216 outputs position information of the infrared ray that is blocked by an object after being emitted from the two light receivers/emitters, to the touch sensor controller 215. Based on the position information of the infrared ray, the touch sensor controller 215 detects a specific coordinate that is touched by the object. The touch sensor controller 215 further includes a communication circuit 215a for wireless communication with the electronic pen 2500. For example, when communication is performed in compliance with a standard such as BLUETOOTH (registered trademark), a commercially available pen can be used. If one or more pens 2500 are registered in the communication unit 215a in advance, the display apparatus 2 and the pen 2500 communicates with each other without the user's manual operation of configuring connection settings between the pen 2500 and the display apparatus 2.

The power switch 227 turns on or off the power of the display apparatus 2. The tilt sensor 217 is a sensor that detects the tilt angle of the display apparatus 2. The tilt sensor 217 is mainly used to detect whether the display apparatus 2 is being used in any of the installation states of FIG. 8A, FIG. 8B or FIG. 8C. The thickness of characters or the like can be changed automatically based on the detected installation state.

The serial interface 218 is an interface to connect the display apparatus 2 to extraneous sources such as a universal serial bus (USB). The serial interface 218 is used to input information from extraneous sources. The speaker 219 is used for outputting sounds.

The microphone 221 is used for inputting sounds. The wireless communication device 222 communicates with a terminal carried by a user and relays the connection to the Internet, for example. The wireless communication device 222 performs communication in compliance with Wi-Fi, BLUETOOTH (registered trademark) or the like. Any suitable standard can be applied other than the Wi-Fi and BLUETOOTH (registered trademark). The wireless communication device 222 forms an access point. When a user sets a service set identifier (SSID) and a password that the user obtains in advance in the terminal carried by the user, the terminal is connected to the access point.

It is preferable that two access points are provided for the wireless communication device 222 as follows:

(a) Access point->Internet

(b) Access point->Intra-company network->Internet

The access point of (a) is for users other than corporate staffs. Through the access point of (a), such users cannot access the intra-company network, but can use the Internet. The access point of (b) is for corporate staffs as users, and such users can use the intra-company network and the Internet.

The infrared I/F 223 detects another display apparatus 2 provided adjacent to the own display apparatus 2. The infrared I/F 223 detects another display apparatus 2 provided adjacent to the own display apparatus 2 by using the straightness of infrared rays. It is preferable that one infrared I/F 223 is provided on each side. This allows the display apparatus 2 to detect the direction in which another display apparatus 2 is provided. This extends the screen. Accordingly, handwritten information or the like that was previously written on an adjacent display apparatus 2 is displayed, for example. In other words, when it is assumed that an area of one display 220 defines one page, handwritten information on another page can be displayed.

The power control circuit 224 controls the AC adapter 225 and the battery 226, which are power supplies of the display apparatus 2. The AC adapter 225 converts alternating current shared by a commercial power supply into direct current.

In a case where the display 220 is a so-called electronic paper, little or no power is consumed to maintain display of the image. Accordingly, in such case, the handwriting input apparatus can be driven by the battery 226. This makes it possible to use the display apparatus 2 for applications such as digital signage even in places where it is difficult to connect the power supply, such as outdoors.

The display apparatus 2 further includes a bus line 210. The bus line 210 is an address bus or a data bus, which electrically connects the components illustrated in FIG. 9 such as the CPU 201.

The touch sensor 216 is not limited to the optical type. In another example, the touch sensor 216 is a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. The touch sensor 216 can be of a type that does not require an electronic pen to detect whether the pen tip is in contact with the surface of the display 220. In this case, a finger tip or a pen-shaped stick is used for touch operation. In addition, the pen 2500 can have any suitable shape other than a slim pen shape.

Functions:

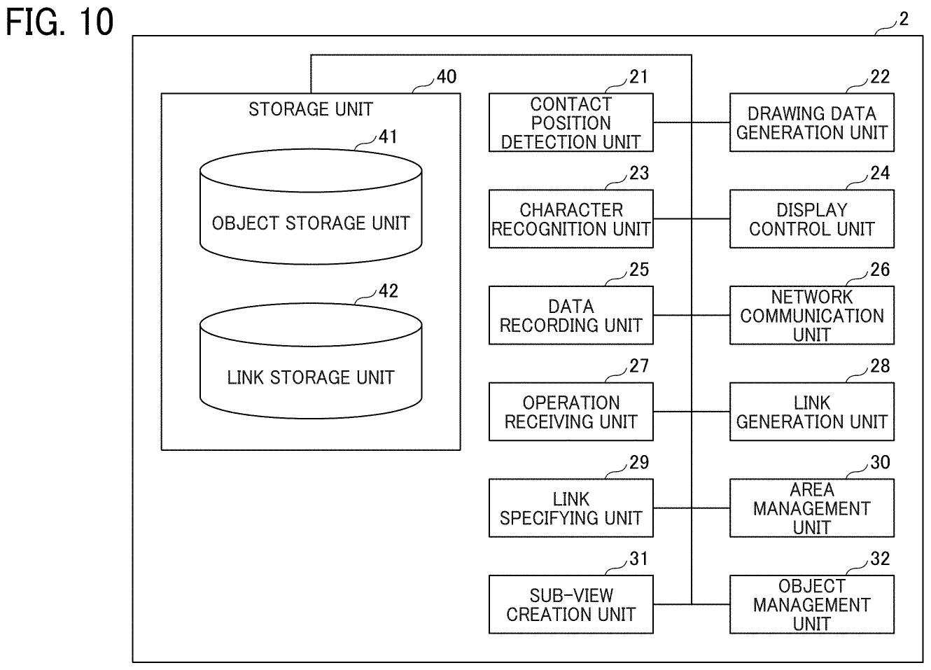

A description is now given of a functional configuration of the display apparatus 2 according to the present embodiment, with reference to FIG. 10. FIG. 10 is a block diagram illustrating the functional configuration of the display apparatus 2 according to the present embodiment. The display apparatus 2 includes a contact position detection unit 21, a drawing data generation unit 22, a character recognition unit 23, a display control unit 24, a data recording unit 25, a network communication unit 26, an operation receiving unit 27, a link generation unit 28, a link specifying unit 29, an area management unit 30, a sub-view creation unit 31, and an object management unit 32. The functional units of the display apparatus 2 are implemented by or are caused to function by operation of any of the elements illustrated in FIG. 9 according to an instruction from the CPU 201 according to a program loaded from the SSD 204 to the RAM 203.

The contact position detection unit 21 detects coordinates of a position where the pen 2500 touches with respect to the touch sensor 216. The drawing data generation unit 22 acquires the coordinates (i.e., contact coordinates) of the position touched by the pen tip of the pen 2500 from the contact position detection unit 21. The drawing data generation unit 22 connects coordinate points into a coordinate point sequence by interpolation, to generate stroke data.

The character recognition unit 23 performs character recognition processing on one or more pieces of stroke data (handwritten data), namely the stroke data corresponding to one or more strokes, handwritten by the user and converts the stroke data into character codes. The character recognition unit 23 reads characters (multilingual languages such as English as well as Japanese), numbers and symbols (%, $, &, etc.), figures (lines, circles, triangles, etc.) concurrently with a pen operation by a user. Although various algorithms have been proposed for the recognition method, a detailed description is omitted on the assumption that known techniques can be used in the present embodiment.

The display control unit 24 displays, on the display 220, for example, handwritten data, a character string converted from the handwritten data, and an operation menu with which a user perform an operation.

The data recording unit 25 stores handwritten data input on the display apparatus 2, a converted character string, a screen (screen data) of a personal computer (PC), a file, and the like in an object storage unit 41 of a storage unit 40. Each of the handwritten data, the character string (including graphic), the image such as a PC screen, the file, and the like is treated as an object. With respect to handwritten data, a set of pieces of stroke data is one object. The set of pieces of stroke data is defied by time, for example, due to interruption of input of handwriting. In addition, set of pieces of stroke data is defied by a position where the handwriting is input.

The network communication unit 26 connects the network controller 205 to a network such as a local area network (LAN), and transmits and receives data to and from other devices via the network.

The object management unit 32 mainly determines which object is selected by the user based on the coordinates detected by the contact position detection unit 21. The object management unit 32 holds the selected object in a selected state.

The link generation unit 28 sets a link between two objects designated by the user (generates link information). To generate link means to associate two or more objects with each other.

A link specifying unit 29 specifies link information set to an object designated by a user. When the user selects an area based on stroke data instead of an object as a link destination, the area management unit 30 manages the coordinates of the area set as the link destination.

A sub-view creation unit 31 creates a thumbnail including link destination peripheral information as a sub-view so that display is not completely switched when a link destination is being displayed. The thumbnail refers to an image that is reduced so that the entire image is displayed.

In addition, the display apparatus 2 includes the storage unit 40 implemented by, for example, the SSD 204 or the RAM 203, which is illustrated in FIG. 9. The storage unit 40 includes the object storage unit 41 and a link storage unit 42.

TABLE 1

| OBJECT | | | COOR- | | |
|---|---|---|---|---|---|
| ID | TYPE | PAGE | DINATES | SIZE | . . . |
| 1 | HANDWRITING | 1 | x1, y1 | W1, H1 | . . . |
| 2 | TEXT | 1 | x2, y2 | W2, H2 | . . . |
| 3 | GRAPHIC | 1 | x3, y3 | W3, H3 | . . . |
| 4 | IMAGE | 2 | x4, y4 | W4, H4 | . . . |
| 5 | GRAPHIC | 3 | x5, y5 | W5, H5 | . . . |
| 6 | TEXT | 4 | x6, y6 | W6, H6 | . . . |
| 7 | IMAGE | 4 | x7, y7 | W7, H7 | . . . |
| . . . | . . . | . . . | . . . | . . . | . . . |

Table 1 schematically illustrates object information stored in the object storage unit 41. The object information is information on objects to be displayed by the display apparatus 2.

“Object identifier (ID)” is identification information identifying an object.

“Type” is a type of object, and the type of object includes, for example, handwrite, text, graphic, and image. “Handwriting” represents stroke data (coordinate point sequence). “Text” represents a character string (character codes) converted from handwritten data. A character string may be referred to as text data. “Graphic” is a geometric shape, such as a triangle or a tetragon, converted from handwritten data. “Image” represents image data in a format such as Joint Photographic Experts Group (JPEG), Portable Network Graphics (PNG), or Tagged Image File Format (TIFF) acquired from, for example, a PC or the Internet.

A screen of the display apparatus 2 may include a page. A page item is indicated by page number.

“Coordinates” represent a position of the object with reference to a predetermined origin on the screen of the display apparatus 2. The position of the object is, for example, the upper left apex of the circumscribed rectangle of the object. The coordinates are expressed, for example, in pixels of the display.

Size represents a width and height of the circumscribed rectangle of the object.

TABLE 2

| | LINK | LINK | LINK | LINK | LINK | |
|---|---|---|---|---|---|---|
| | SOURCE | DESTINATION | DESTINATION | DESTINATION | DESTINATION | |
| LINK | OBJECT | OBJECT | AREA | AREA | AREA | |
| ID | ID | ID | COORDINATES | SIZE | PAGE | . . . |
| 1 | 1 | 3 | — | — | — | . . . |
| 2 | 2 | 4 | — | — | — | . . . |
| 3 | 5 | — | x6, y6 | W6, H6 | — | . . . |
| 4 | 7 | — | — | — | — | . . . |
| . . . | . . . | . . . | . . . | . . . | . . . | . . . |

Table 2 schematically illustrates the link information stored in the link storage unit 42. The link information is information that associates two objects with each other.

“Link ID” is identification information for identifying a link.

“Link source object ID” is an object ID for identifying a link source object. “Link source object” is one of the two objects selected by a user prior to the other one of the two objects, which are associated with each other. The link source object is an example of a first object.

“Link destination object ID” is an object ID for identifying a link destination object. “Link destination object” is one of the two objects selected by a user after the other one of the two objects, which are associated with each other. The link destination object is an example of a second object.

When the link destination is not an object but an area, “link destination area coordinates” are indicated, and the link destination area coordinates area coordinates of the area corresponding to the link destination.

When the link destination is not an object but an area. “link destination size” is indicated, and the link destination size is a size of the area corresponding to the link destination.

When the link destination is a page, “link destination page” is indicated, and the link destination page is a page number corresponding to the link destination. Each page is also treated as an object.

Detailed Example of Associating Objects:

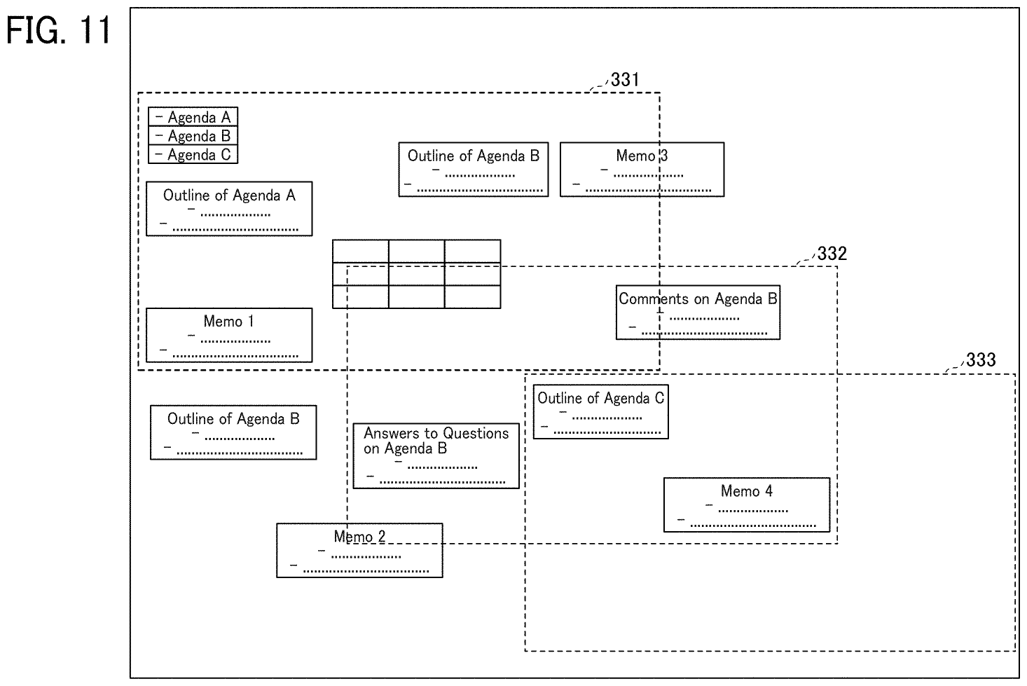

A description is given below of associating objects on a screen, with reference to FIG. 11 to FIG. 20. FIG. 11 is a diagram illustrating a whole page that is an object, according to the present embodiment. Display ranges 331, 332, and 333 are screen ranges (screen views) each of which is to be displayed as a screen by the display apparatus 2. In other words, the display apparatus 2 manages a page that is wider than the display range. The size of a single page is not limited, but is to be large enough to be for normal use. Note that each of the sizes of the display ranges 331, 332, and 333 changes according to an enlargement operation or a reduction operation performed by the user.

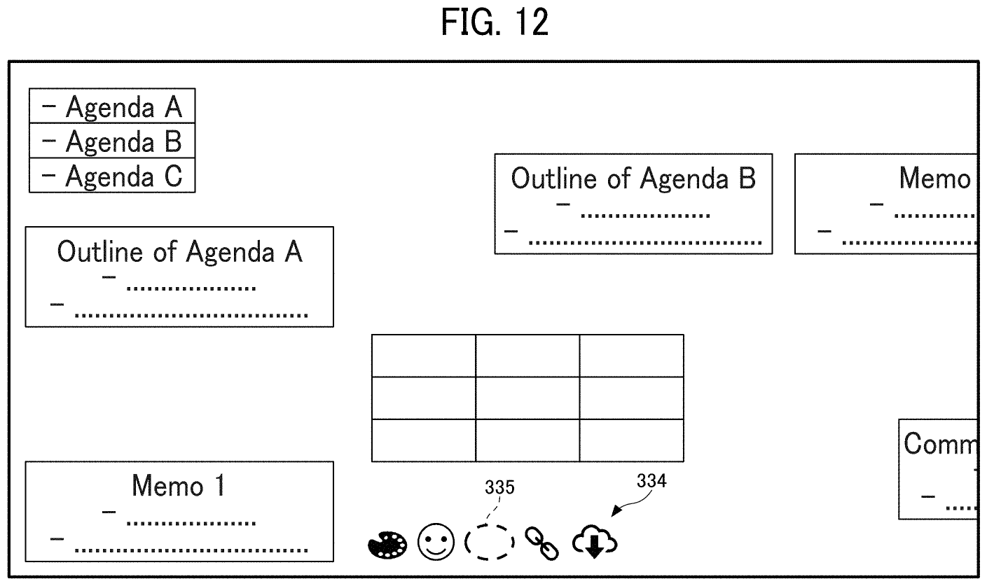

FIG. 12 is a diagram illustrating a first example of a screen displayed by the display apparatus 2 according to the present embodiment. The display apparatus 2 may display a tool tray 334 any time regardless of the display range. According to a user operation, displaying and hiding of the tool tray 334 are switched. Although the tool tray 334 is displayed at the bottom of the display in FIG. 12, the user can change a position of displaying the tool tray 334.

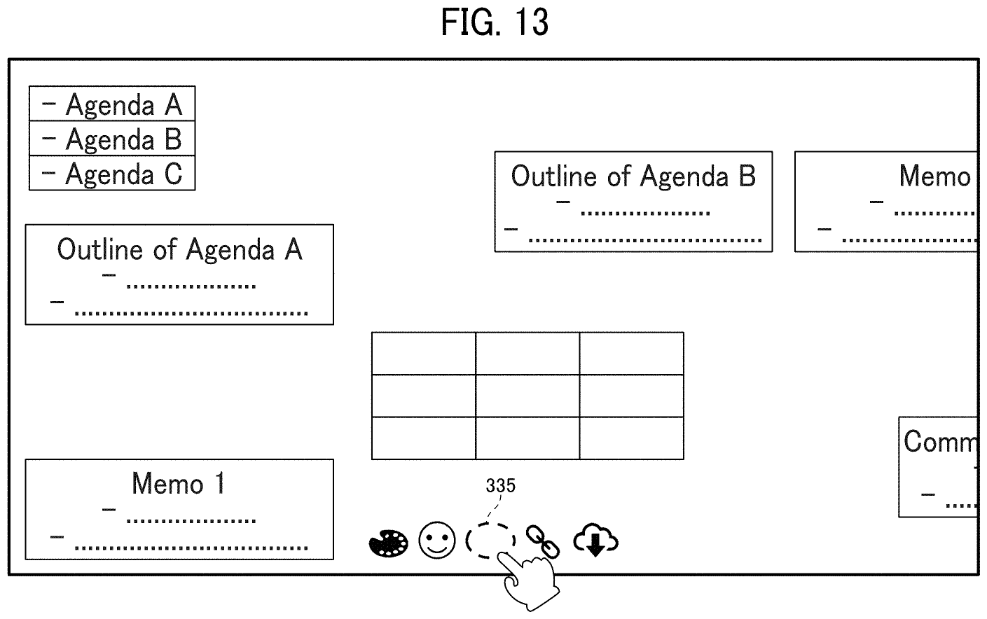

FIG. 13 is a diagram illustrating a second example of a screen displayed by the display apparatus 2 according to the present embodiment. When two objects are to be associated with each other, a “link destination setting tool” 335 is selected from the tool tray 334 according to a user operation. When the operation receiving unit 27 receives the user operation of selecting the link destination setting tool 335, the link destination setting tool 335 is displayed in a selected state. In other words, when an icon of the link destination setting tool 335 is selected, a link setting function is launched. When being in the selected state, the link destination setting tool 335 is highlighted (displayed inverted) or has brightness higher than in a state of not being selected.

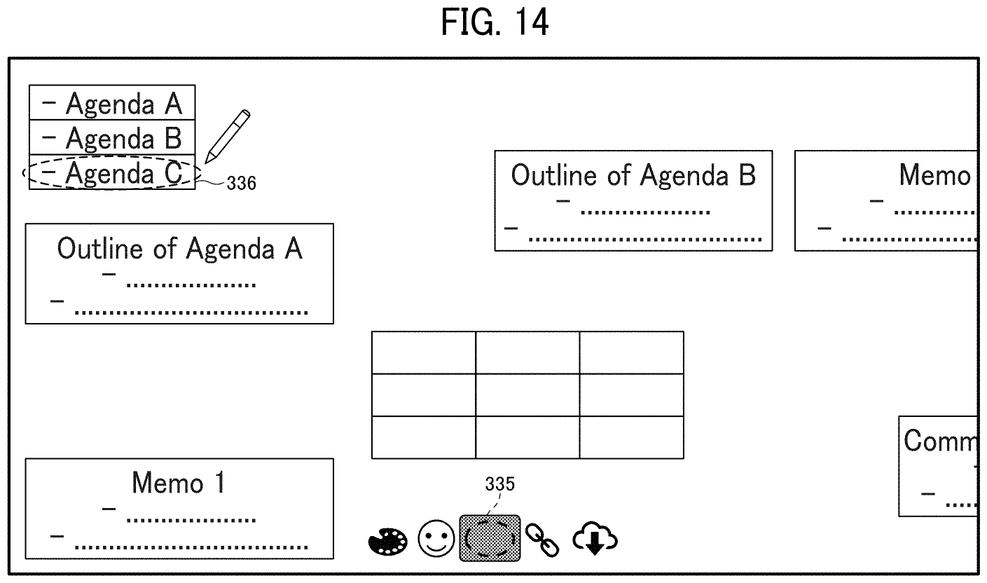

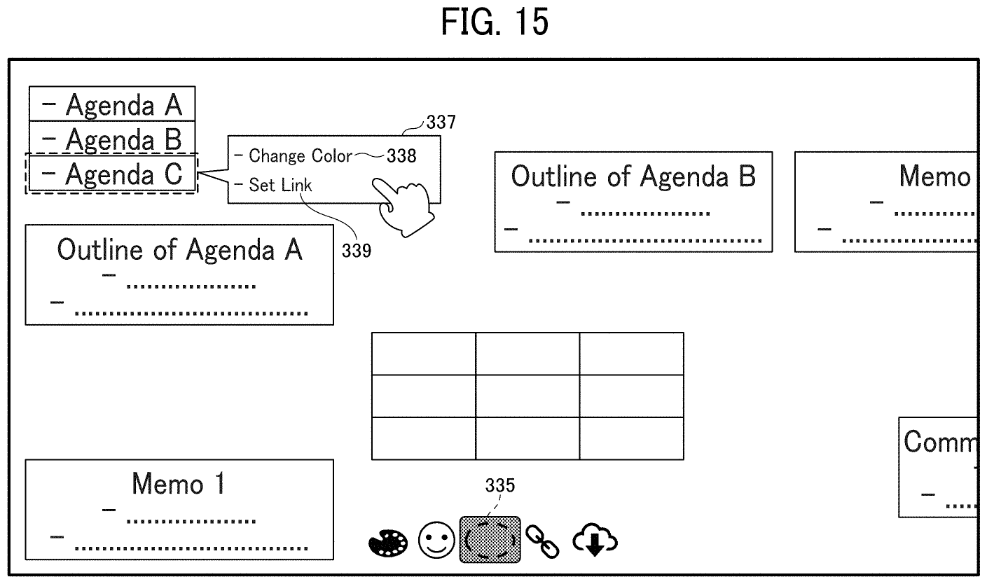

FIG. 14 is a diagram illustrating a third example of a screen displayed by the display apparatus 2 according to the present embodiment. After the link destination setting tool 335 becomes in the selected state, a link source object 336 is pressed or enclosed by stroke data according to a user operation. At this time, the link source object 336 is not associated with another object, and thus is not a link source object, but becomes a link source object when being associated with another object. Pressing includes touching with the pen 2500 or a fingertip and clicking with a pointing device such as a mouse, according to a user operation. In FIG. 14, the link source object 336 is enclosed with the pen 2500 according to a user operation.

The contact position detection unit 21 detects coordinates pressed by a user. The object management unit 32 specifies an object from the object storage unit 41 based on the coordinates. For example, the object management unit 32 specifies an object that has coordinates of center that are the closest to the pressed coordinates within a certain distance. When the pressed coordinates have spread as illustrated in FIG. 14, the object management unit 32 may specify the center of the spread.

FIG. 15 is a diagram illustrating a fourth example of a screen displayed by the display apparatus 2 according to the present embodiment. The display control unit 24 displays a menu 337 that is operable by the user in relation to the link source object 336 selected by the object management unit 32. In FIG. 15, the menu 337 includes items of “Change Color” 338 and “Set Link” 339. The user who desires to set a link between objects presses the item of “Set Link” 339.

When the operation receiving unit 27 receives the operation of pressing the item of “Set Link” 339, the object management unit 32 transmits to the link generation unit 28 the object information on the link source object 336, which is selected by the user. The link generation unit 28 shifts to a link destination selection wait state and waits for the information on a link destination object to be transmitted.

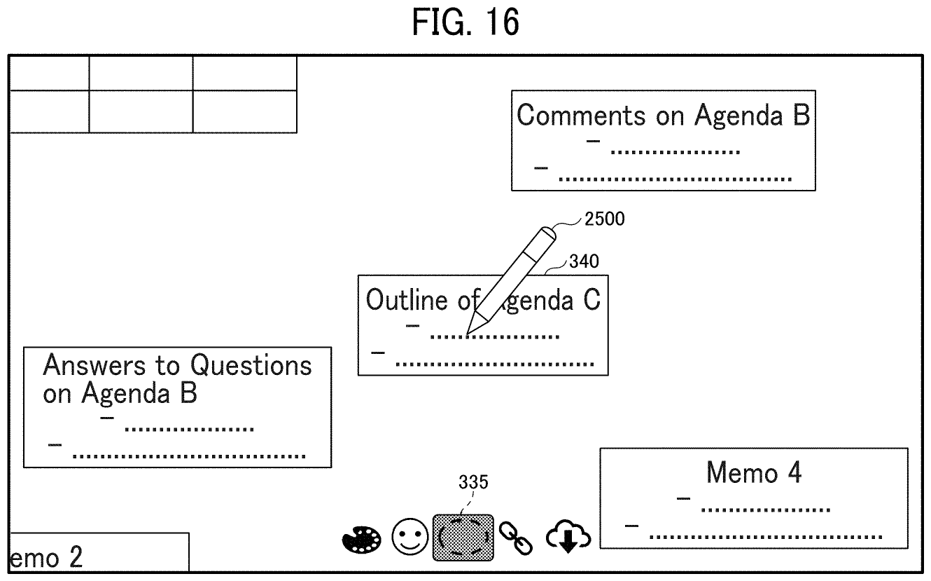

FIG. 16 is a diagram illustrating a fifth example of a screen displayed by the display apparatus 2 according to the present embodiment. A display range of the example of FIG. 16 is different from, for example, the ones of FIG. 12 to FIG. 15 because, the display range has changed according to a user operation in order to select a link destination object. A link destination object 340 is selected according to a user operation, as illustrated in FIG. 16. Any desired object may be selected to be a link destination object by being associated with the link source object.

The contact position detection unit 21 detects coordinates pressed by a user. The object management unit 32 specifies the link destination object 340 from the object storage unit 41 based on the coordinates. For example, the object management unit 32 specifies the link destination object 340 that has coordinates of center that are the closest to the pressed coordinates within a certain distance. The object management unit 32 transmits the object information of the specified link destination object to the link generation unit 28.

After obtaining the object information of the link source object and the object information of the link destination object, the link generation unit 28 adds these two object IDs to the link storage unit 42 corresponding to Table 2 in association with each other. When an area having no object is selected by a user operation, the link generation unit 28 adds the coordinates and the size of the area to the link storage unit 42. When a page (saved pages are displayed as thumbnails) is selected by a user operation, the link generation unit 28 adds a link source object and the page corresponding to the link destination to the link storage unit 42.

Searching Object Storage Unit and Adding to Link Storage Unit:

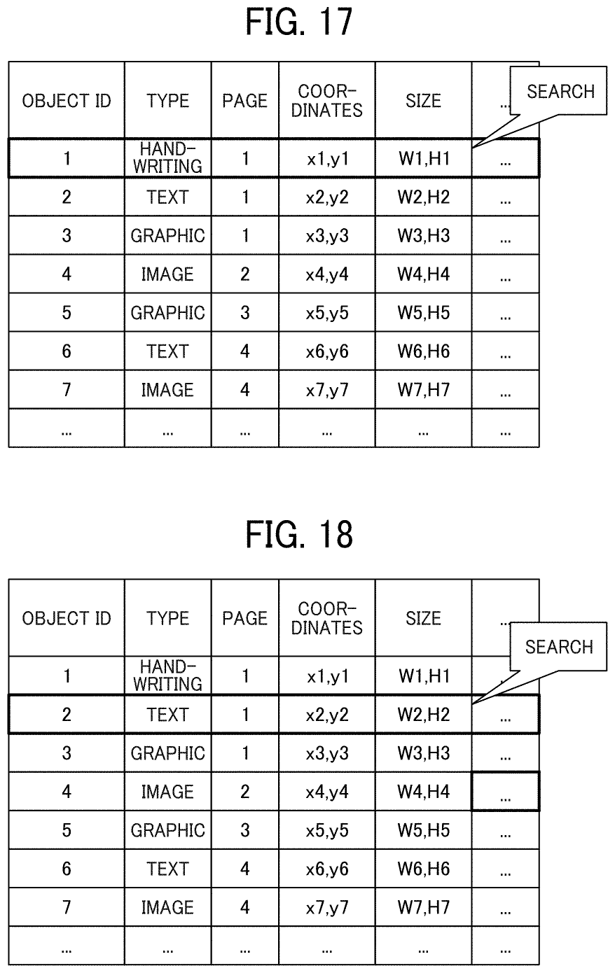

A description is given below of the association of two objects with reference to FIG. 17 to FIG. 19, by focusing on the object storage unit 41 and the link storage unit 42. FIG. 17 is a diagram illustrating a table used to specify a link source object in the object storage unit 41, according to the present embodiment. As illustrated in FIG. 14, when the user selects a link source object, the object management unit 32 searches the object storage unit 41. This search refers to specifying an object having coordinates of center that are the closest to the pressed coordinates within a certain distance. The link source object may be limited to an object within a certain distance from the coordinates pressed according to a user operation or may not be limited to such an object. The object management unit 32 specifies an object having an object ID that is 1.

FIG. 18 is a diagram illustrating a table used to specify a link destination object, according to the present embodiment. When the user selects a link destination object as illustrated in FIG. 16, the object management unit 32 searches the object storage unit 41 for an object having coordinates of center that are the closest to the pressed coordinates within a certain distance. The object management unit 32 specifies an object having an object ID that is 2.

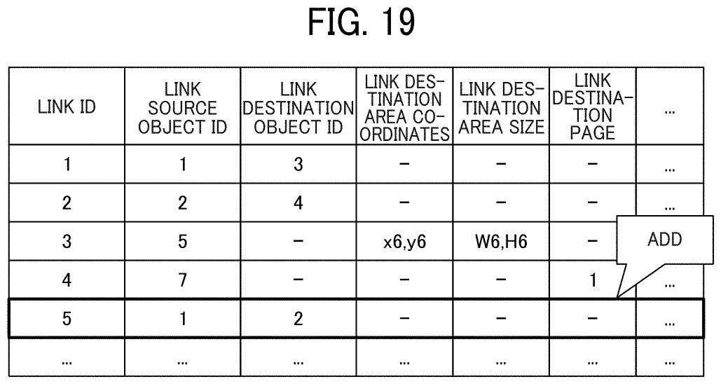

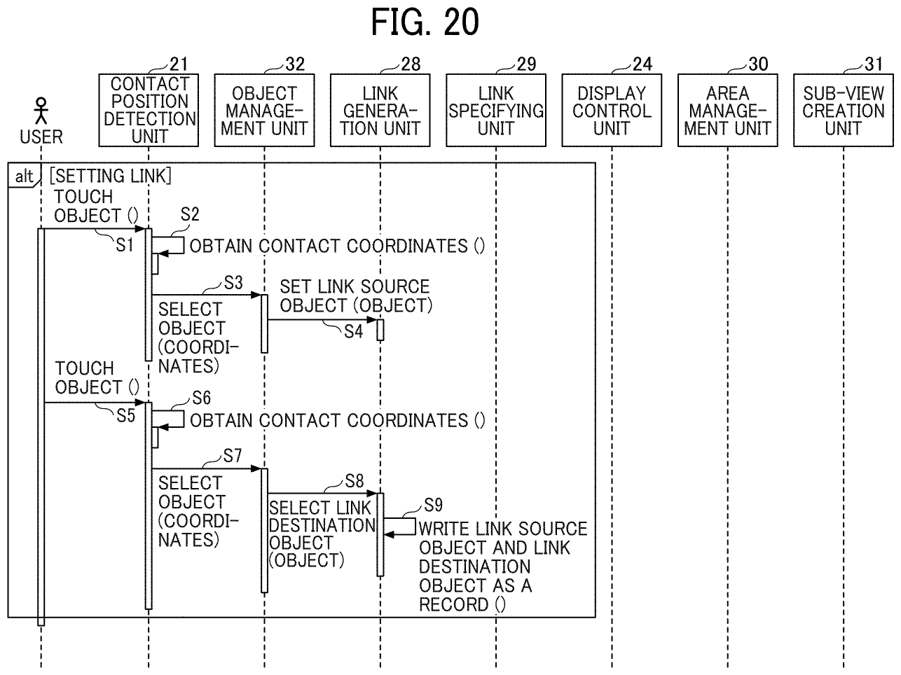

FIG. 19 is a diagram illustrating a table used to add a record to the link storage unit 42 according to the present embodiment. A single record is a piece of data in the database. In the present embodiment, a record is referred to as link information. The link generation unit 28 receives the object ID that is 1 as the link source object ID and the object ID that is 2 as the link destination object ID. The link generation unit 28 sets “1” to the link source object ID and 2 to the link destination object ID in the link storage unit 42.

By setting the link information in the link storage unit 42, when the user selects the link source object, the display apparatus 2 displays the link destination object.

Associating Objects with Each Other:

FIG. 20 is a sequence diagram illustrating a process of setting a link between two objects to be associated with each other performed by the display apparatus 2, according to the present embodiment.

S1: After the user presses the link destination setting tool 335 in FIG. 13 and the item of “Set Link” 339 in FIG. 15, the user presses a link source object.

S2: The contact position detection unit 21 detects coordinates (first coordinates that is corresponding to the link source object) pressed according to a user operation.

S3: The contact position detection unit 21 requests the object management unit 32 to select an object corresponding to the coordinates by specifying the coordinates pressed according to a user operation.

S4: The object management unit 32 searches the object storage unit 41 with the coordinates pressed according to a user operation, and specifies the link source object in the object storage unit 41. The object management unit 32 notifies the link generation unit 28 of an object ID of the object as the link source object.

S5: Next, the user presses a link destination object.

S6: The contact position detection unit 21 detects coordinates (second coordinates that is corresponding to the link destination object) pressed according to a user operation.

S7: The contact position detection unit 21 requests the object management unit 32 to select an object corresponding to the coordinates by specifying the coordinates pressed according to a user operation.

S8: The object management unit 32 searches the object storage unit 41 with the coordinates pressed according to a user operation, and specifies the link destination object in the object storage unit 41. The object management unit 32 notifies the link generation unit 28 of an object ID of the object as the link destination object.

S9: The link generation unit 28 sets the link source object ID and the link destination object ID in the link storage unit 42. Specifically, the link generation unit 28 stores link information, which associates the link source object and the link destination object, in the link storage unit 42, for example, as described above referring to FIG. 19.

As described above, the display apparatus 2 according to the present embodiment associates the two objects with each other and sets a link between the two objects according to the user operations.

Displaying Objects Using Link Information:

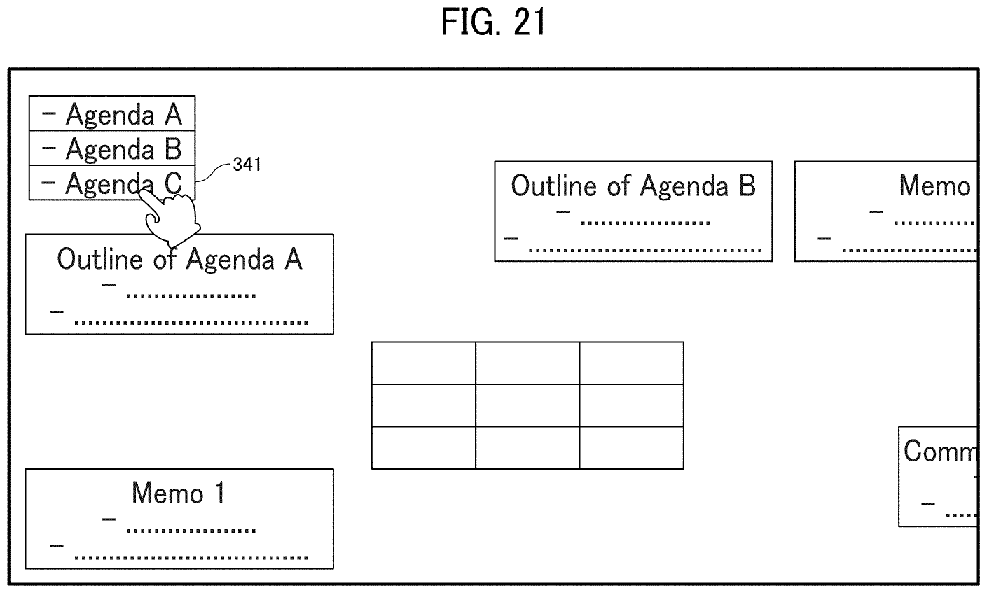

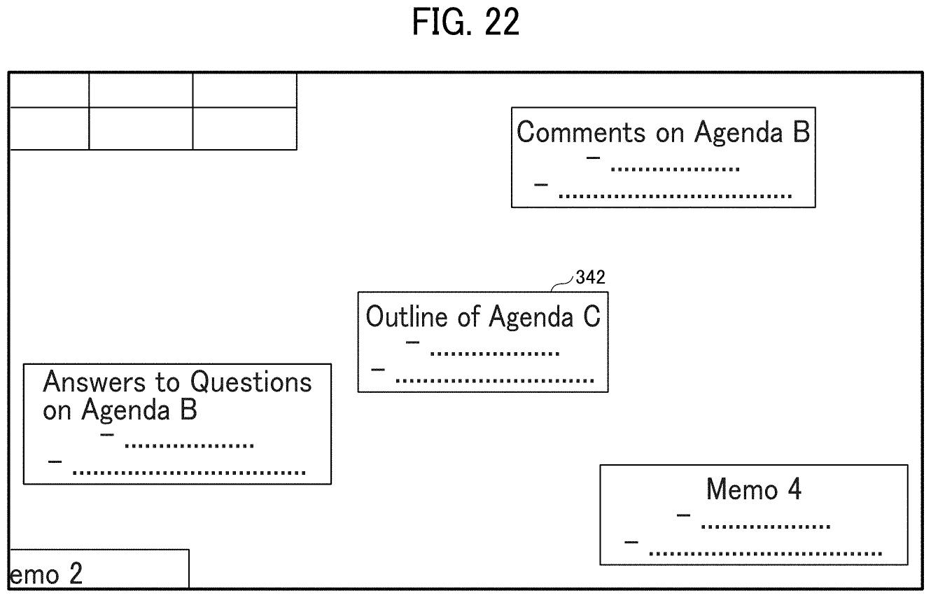

A description is given below of display of an object using the link information with reference to FIG. 21 and FIG. 22.

FIG. 21 is a diagram illustrating a screen on which a link source object is being selected, according to the present embodiment. As illustrated in FIG. 21, a link source object 341 to which the generated link is set is selected according to a user operation. The object management unit 32 specifies the link source object 341 based on the coordinates pressed according to a user operation. The object management unit 32 transmits the object ID of the specified link source object 341 to the link specifying unit 29. The link specifying unit 29 searches the object ID from the link source object IDs in the link storage unit 42. When the same object ID is found as the link source object ID, the link specifying unit 29 transmits the corresponding link destination object ID to the object management unit 32 and acquires the object information of the object specified by the link destination object ID.

The link specifying unit 29 acquires the object information of the link destination object from the object management unit 32, and requests the display control unit 24 to display the object and surroundings of the object. A display control unit 24 displays the link destination object by switching to the designated link destination object and surroundings of the designated link destination object within a display range.

FIG. 22 is a diagram illustrating a screen displaying a display range including the link destination object, according to the present embodiment. In the example of FIG. 22, a link destination object 342 pressed according to a user operation and associated with the link source object 341 and surroundings of the link destination object 342 are displayed.

As described above, the link destination object is displayable by pressing the link source object according to a user operation.

Searching Object Storage Unit and Searching Link Storage Unit:

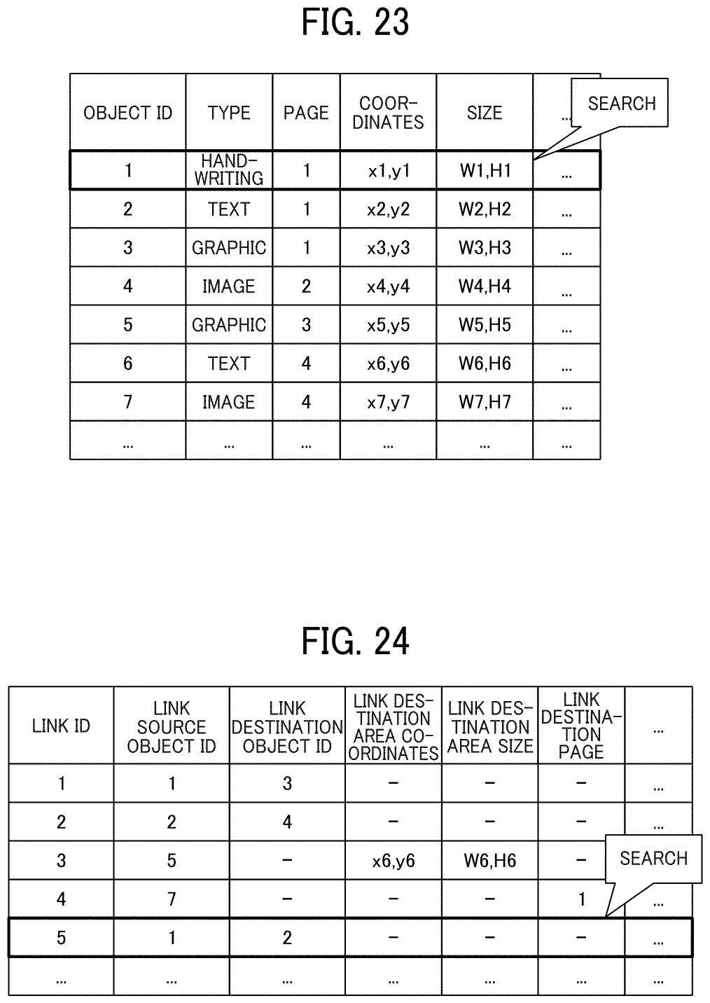

With reference to FIGS. 23 to 25, display of a link destination object is described by focusing on the object storage unit 41 and the link storage unit 42. FIG. 23 is a diagram illustrating a table used to search for a link source object in the object storage unit 4, according to the present embodiment. As illustrated in FIG. 21, when the link source object 341 is pressed according to a user operation, the object management unit 32 searches the object storage unit 41 with the coordinates pressed according to a user operation. The search method may be substantially the same as the method of associating two links. The object management unit 32 specifies an object having an object ID that is 1.

FIG. 24 is a diagram illustrating a table used to search for the link source object in the link storage unit 42, according to the present embodiment. The link specifying unit 29 searches for link information (record) to which the object ID that is 1 is set as the link source object ID. The link specifying unit 29 finds the link information of a link ID that is 5 and specifies the link destination object having the link destination object ID that is 2.

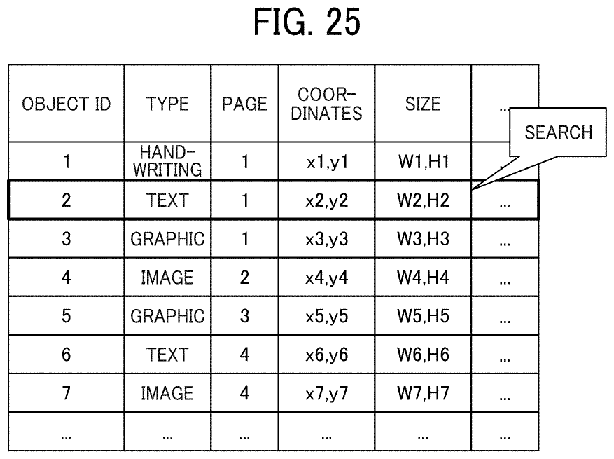

FIG. 25 is a diagram illustrating a table used to search for a link destination object in the object storage unit 41, according to the present embodiment. The object management unit 32 searches the object storage unit 41 for an object having an object ID that is 2 (link destination object ID that is 2). As a result, the object management unit 32 identifies a page, coordinates, and a size corresponding to the link destination object. Accordingly, the display control unit 24 displays the link destination object in a display range including the link destination object and surroundings of the link destination object. The display range is, for example, a range that has the center of the link destination object as the center of the range. The size of the display range is determined in accordance with a current display scale factor set by the user. A description of changing the display scale factor is given later.

Displaying Object by Using Link Information:

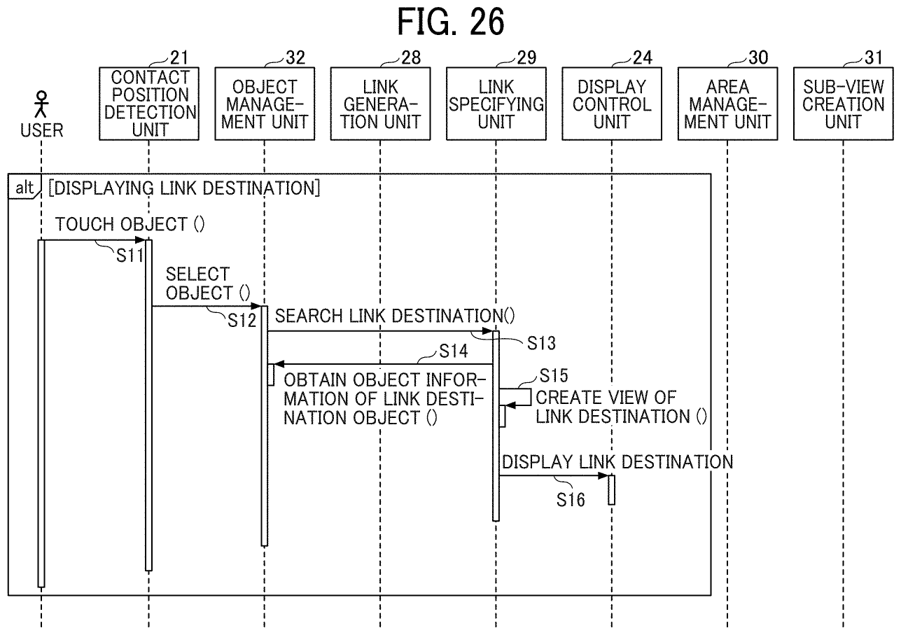

FIG. 26 is a sequence diagram illustrating a process, performed by the display apparatus 2, of displaying a link destination object based on the link information in response to a user operation of pressing a corresponding link source object, according to the present embodiment.

S11: A link source object is pressed according to a user operation. A certain menu may be selected before the link source object is selected.

S12: The contact position detection unit 21 detects coordinates pressed according to a user operation and requests the object management unit 32 to select an object by specifying the coordinates pressed according to a user operation. The object management unit 32 specifies a link source object ID from the object storage unit 41 based on the coordinates pressed according to a user operation.

S13: The object management unit 32 requests the link specifying unit 29 to search for a link destination object by specifying the link source object ID. In response to the request, the link specifying unit 29 searches the data item of link source object ID of the link storage unit 42 by using the link source object ID transmitted from the object management unit 32, and specifies a link destination object ID.

S14: The link specifying unit 29 acquires object information of the link destination object from the object management unit 32 by specifying the link destination object ID.

S15: The link specifying unit 29 generates a display range (view (screen view), screen range) based on the object information of the link destination object. The display range is, for example, a range to be displayed and that has a predetermined number of pixels from the center that is also the center of the link destination object to up, to down, to left, and to right.

S16: The link specifying unit 29 requests the display control unit 24 to switch a current display range to the display range by specifying the display range including the link destination object so that the link destination object is to be displayed.

As described above, the display apparatus 2 according to the present embodiment allows the user to set the association between objects. When the two objects are associated with each other, the link destination object is displayable in response to the user operation of pressing the link source object.

In the present embodiment, the link destination object is displayed by selecting the link source object, but the link source object may be displayed by selecting the link destination object.

### Second Embodiment

Case where Area is Selected as Link Destination:

A description is given below of a case in which an area is selected as a link destination object according to a second embodiment. In the present embodiment, the hardware configuration illustrated in FIG. 9 and the functional configuration illustrated in FIG. 10 in the above-described embodiment are applicable.

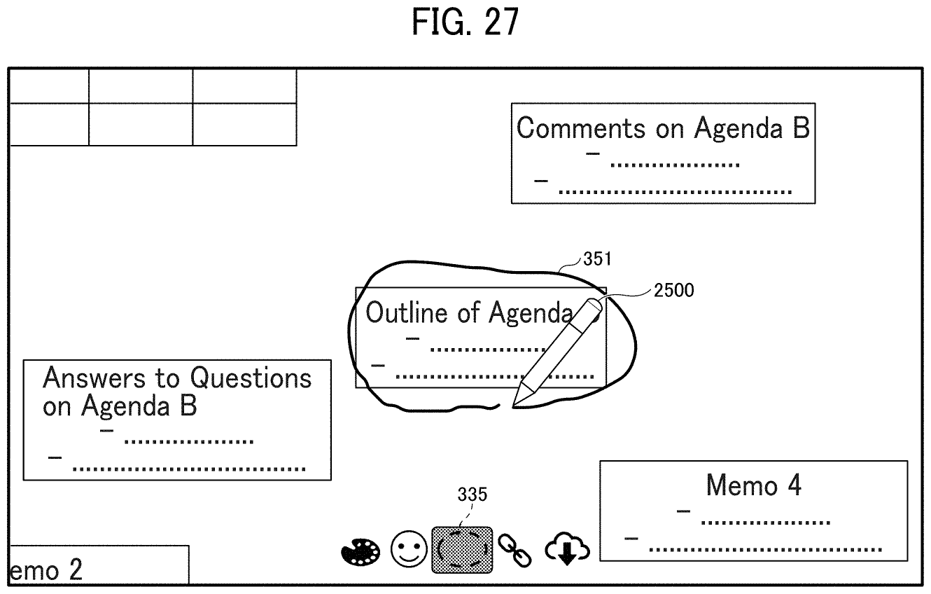

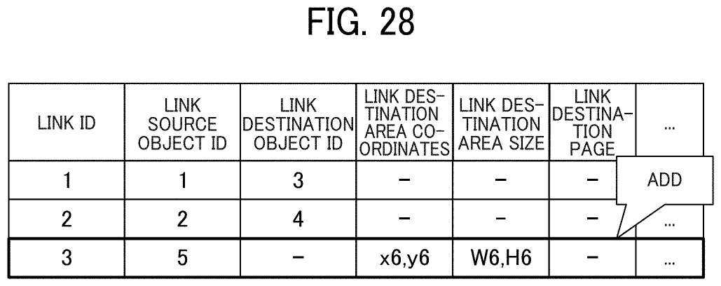

A description is given below of a case where a user selects an area as a link destination object to which a link with a link source object is to be set by using stroke data representing a stroke enclosing the area, with reference to FIG. 27 and FIG. 28. In this case, the link generation unit 28 sets the area as a link destination in alternative to a text box or the like.

FIG. 27 is a diagram illustrating a screen on which stroke data representing a stroke is being input by handwriting of a user to select an area, according to the present embodiment. When the user selects the area, the area management unit 30 detects coordinates of the upper left vertex of the circumscribed rectangle or the inscribed rectangle as coordinates of the link destination based on stroke data 351 detected by the contact position detection unit 21. The area management unit 30 transmits the coordinates of the upper left vertex and the height and width indicating a size of the circumscribed rectangle or the inscribed rectangle to the link generation unit 28.

FIG. 28 is a diagram illustrating a table used to set an area as a link destination in the link storage unit 42 according to the present embodiment. The link generating unit 28 sets the link source object ID, the link destination area coordinates, and the link destination area size in the link storage unit 42. Since the area as a link destination is not actually managed as an object having an object ID, a field corresponding to the data item of link destination object ID remains a blank.

As described above, any desired area is settable as a link destination object. Although a text box is surrounded by the stroke data 351 in the example of FIG. 27, the area designated by the stroke data 351 may have no text box, stroke data, or the like.

In addition, in the present embodiment, the link destination object is designated as an area, but the link source object may also be designated as an area.

Associating Objects with Each Other:

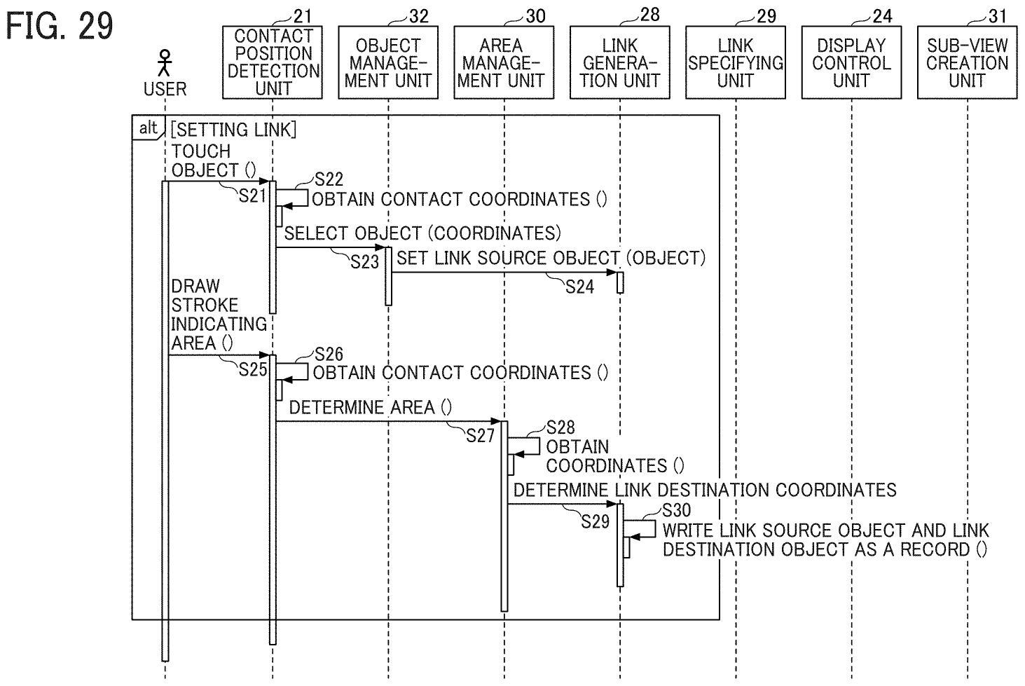

FIG. 29 is a sequence diagram illustrating a process of setting a link between an object and an area to be associated with each other performed by the display apparatus 2, according to the present embodiment. In the following description of the example of FIG. 29, differences from the example of FIG. 20 are described.

S21 to S24: The processing is substantially the same as steps S1 to S4 in FIG. 20.

S25: An area corresponding to a link destination is enclosed by using stroked data according to a user operation.

S26: The contact position detection unit 21 detects coordinates of the stroke data representing handwriting of the user.

S27: The contact position detection unit 21 requests the area management unit 30 to determine the area by specifying the coordinates of the stroke data because the stroke data is not a single point but has spread.

S28: The area management unit 30 determines whether the circumscribed rectangle of the coordinates of the stroke data representing a stroke from the start point to the end point is equal to or greater than a threshold value. When the circumscribed rectangle is equal to or greater than the threshold value, the area management unit 30 determines coordinates of the upper left vertex of the circumscribed rectangle or the inscribed rectangle of the stroke data, and the height and the width indicating the size.

S29: The area management unit 30 transmits the coordinates of the upper left vertex of the circumscribed rectangle or the inscribed rectangle, and the height and the width indicating the size to the link generation unit 28 as area information.

S30: The link generation unit 28 sets the link source object ID, the coordinates of the area, and the height and the width indicating the size in the link storage unit 42 in association with each other.

As described above, the display apparatus 2 according to the present embodiment allows the user to set a link between an object and any desired area to associate the object and the area in association with each other.

### Third Embodiment

Displaying Link Destination Object or Link Destination Area by Changing Display Scale:

A description is given below of display of a link destination object or a link destination area by changing display scale (display scaling factor) according to a third embodiment. In the present embodiment, the hardware configuration illustrated in FIG. 9 and the functional configuration illustrated in FIG. 10 in the above-described embodiment are applicable.

The link specifying unit 29 determines a display range of the link destination object or the link destination area, by applying that of the link source object selected by the user. However, there may be a case in which the display range of the link destination object or the link destination area is large, the display apparatus 2 may fail to display the entire link destination object or the entire link destination area on the display.

In such a case, the link specifying unit 29 calculates an appropriate display scale factor, switches the display scale factor, and displays the link destination object or the link destination region.

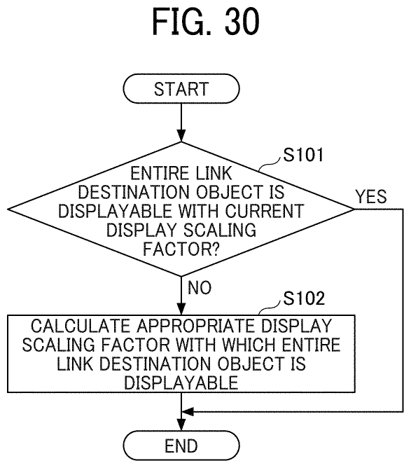

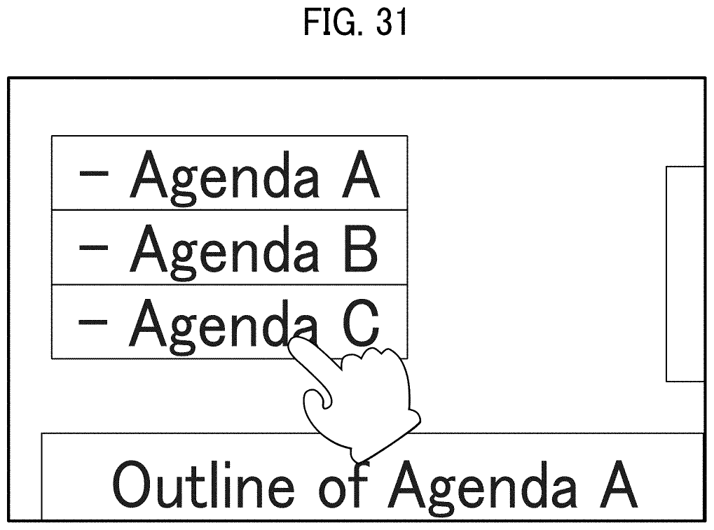

FIG. 30 is a flowchart illustrating a process of determining a display scale factor performed by the display control unit 24 according to the present embodiment. The link specifying unit 29 determines whether the entire link destination object is displayable with the current display scale factor (S101). A detailed description of the determination is given later.

When the determination of step S101 is No, the link specifying unit 29 calculates an appropriate display scale factor with which the entire link destination object is displayable (S102).

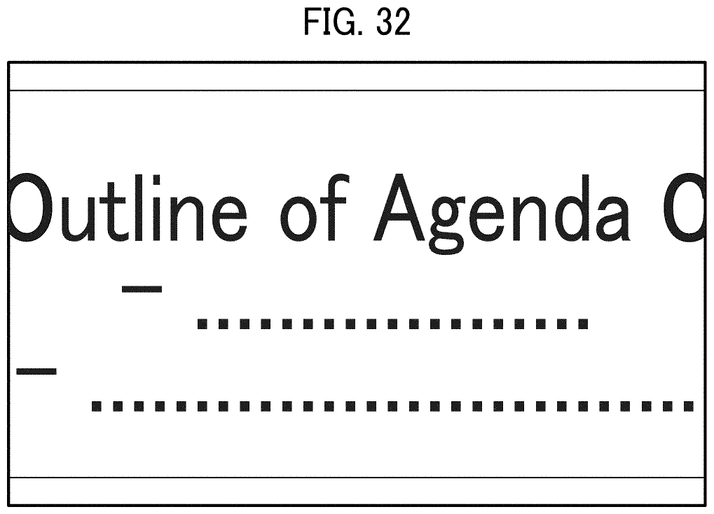

FIG. 31 is a diagram illustrating a screen displaying a display range having been enlarged and on which a link source object is being selected, according to the present embodiment. In displaying the link destination object, the link specifying unit 29 acquires a size of the link destination object from the object management unit 32. Then, the link specifying unit 29 determines whether the entire link destination object is displayable when the display range is switched while keeping the current display scale factor.

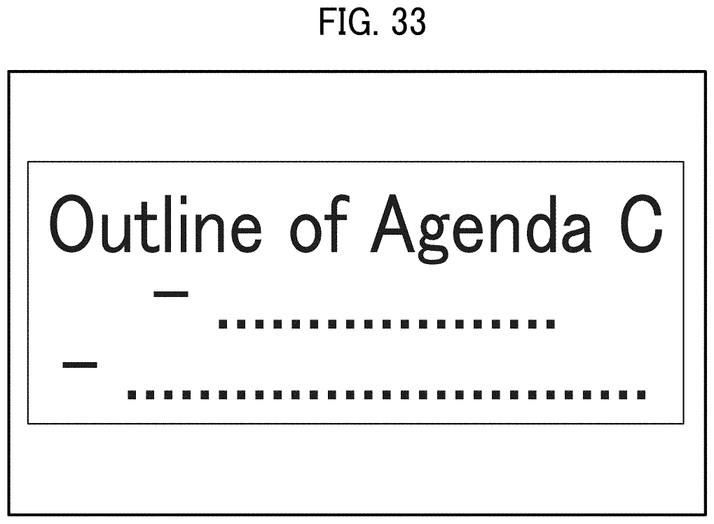

FIG. 32 is a diagram illustrating a link destination object being displayed with a current display scale factor on a screen, according to the present embodiment. In the example FIG. 32, the link display object is not small enough to be actually displayed on the screen, and a part of the link display object is not displayed on the screen. A description is given below of determining whether the entire link destination object is displayable. The link specifying unit 29 holds a standard width and a standard height with which the entire object is displayable in case of a standard scaling factor. When the display scale factor is n, a width and a height of an object or a region are each increased by n times. Assuming that the current display scale factor is n, the link specifying unit 29 compares the standard width and the standard height with values obtained by multiplying the width and the height of the link destination object or the link destination area by n.

In the case of FIG. 32, the link specifying unit 29 determines that the link destination object does not fit into the screen of the display in a width direction.

FIG. 33 is a diagram illustrating a screen after changing a setting of display scale factor, according to the present embodiment. The object management unit 32 calculates a ratio of the standard width to a value obtained by multiplying the width of the link destination object by n (width/standard width). Then, the object management unit 32 multiplies the inverse of the ratio by the current display scale factor n.

Accordingly, the link specifying unit 29 determines the display scale factor with which the entire link destination object is displayable in the display range. In each example of FIG. 31 to FIG. 33, as an example of the link destination object, a text box is used, but the same applies to a case where the link destination object is an area.

Further, when the link destination object is too small with respect to the display range with the current display scale factor, the link specifying unit 29 reduces the display scale factor (for example, when being 10, the display scale factor is reduced to about 2). When the display range is switched with the current display scale factor, the link specifying unit 29 determines whether a size (smaller value of the width and the height) of the link destination object is equal to or smaller than a threshold value. In this case, the link specifying unit 29 determines the display scale factor in a manner that the size of the link destination object becomes approximately equal to the threshold value. For example, the link specifying unit 29 multiplies the current display scale factor by the inverse of “the size of the link destination object/the threshold.” In this way, the link specifying unit 29 determines the display scale factor with which the link destination object having a suitable size (that is not too small) is displayed in the display range.

### Fourth Embodiment

Displaying Position of Link Destination Object or Link Destination Area:

A description is given below of a display position of a link destination object or a link destination area according to a third embodiment. In the present embodiment, the hardware configuration illustrated in FIG. 9 and the functional configuration illustrated in FIG. 10 in the above-described embodiment are applicable.

In the example of FIG. 22, the link specifying unit 29 displays the link destination object at the center of the screen of the display. The link specifying unit 29 may determine a position at which a link destination object or a link destination area is to be displayed on a screen of the display.

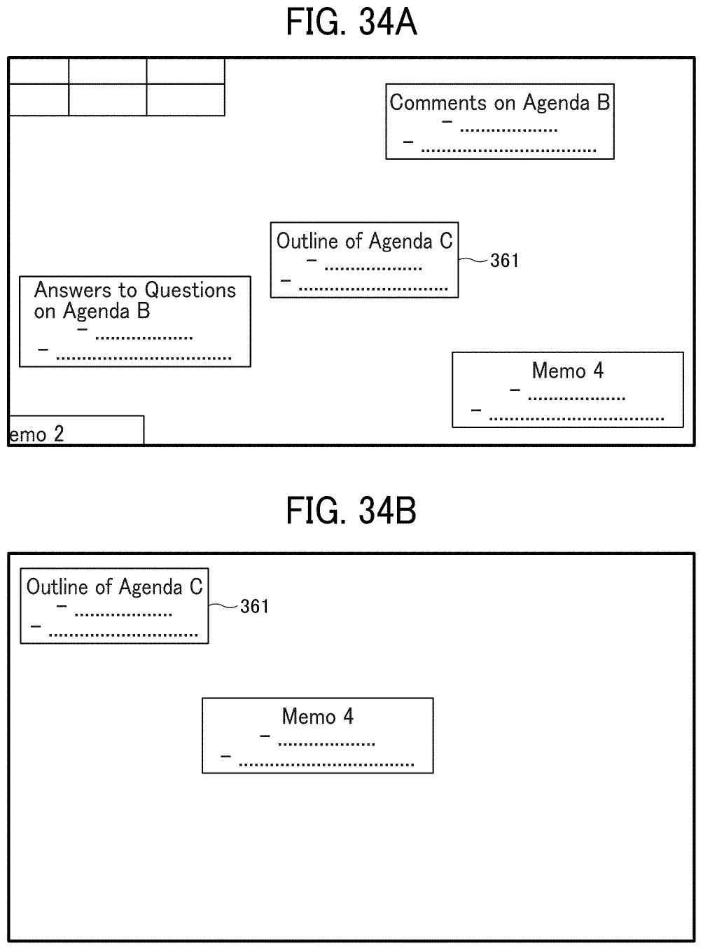

FIG. 34A is a diagram illustrating a screen on which a link destination object 361 is displayed on a center of the screen of the display, according to the present embodiment. The link destination object 361 being displayed at the center of the screen of the display allows the user to easily grasp objects around the link destination object 361.

FIG. 34B is a diagram illustrating a screen on which the link destination object 361 is displayed on an upper left of the screen of the display, according to the present embodiment. The link destination object 361 being displayed at the upper left of the screen of the display allows the user to easily write about the link destination object 361 below the link destination object 361.

In view of the above, when a link destination object is a character string, the link specifying unit 29 determines a position on the screen to display the link destination object or the link destination area is to be displayed in accordance with a written direction of the language of the character string.

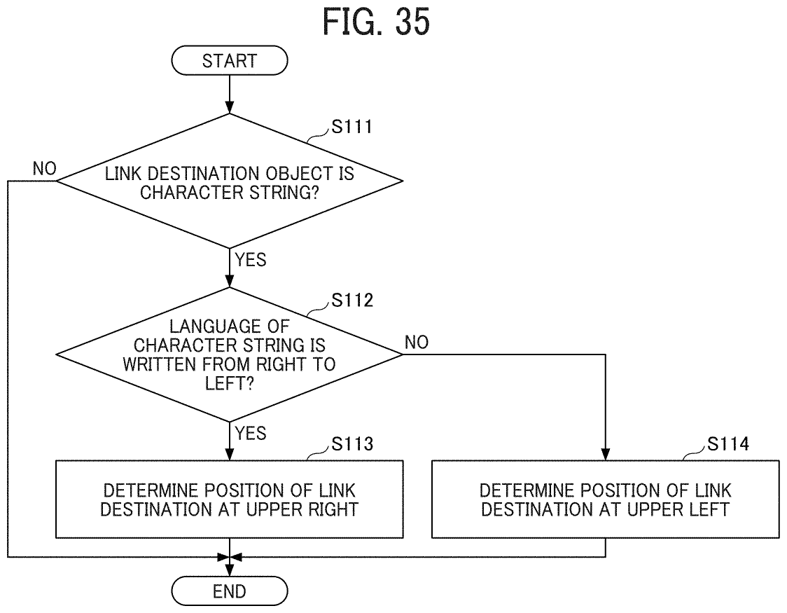

FIG. 35 is a flowchart illustrating a process of determining a display position of a link destination object or a link destination area by the link specifying unit 29 according to the present embodiment.

The link specifying unit 29 determines whether the link destination object is a character string (text) based on the data item indicating a type of object in the object information (S11).

When the type of object is a character string (text), the link specifying unit 29 determines whether the language of the character string is written from right to left or from left to right (S112). More specifically, the link specifying unit 29 identifies the language base on a character code, at first. Then, in order to determine the language is one that is written from right to left, the link specifying unit 29 refers to a list of languages that is written from right to left, because the number of languages written from right to left is less than the number of languages written from left to right. The list of languages (language list) is prepared in advance.

The link specifying unit 29 determines the display position to be at upper right in case that the language is written from write to left (S113). The link specifying unit 29 determines the display position to be at upper left in case that the language is written from left to write (S114). The link specifying unit 29 instructs the display control unit 24 for the display range to be switched.

This allows the user to easily input another object by handwriting based on the display position of the link destination object that is regarded as a reference point.

### Fifth Embodiment

Setting Link Destination by Using Object List:

A description is given below of setting a link destination by using an object list according to a fourth embodiment. In the present embodiment, the hardware configuration illustrated in FIG. 9 and the functional configuration illustrated in FIG. 10 in the above-described embodiment are applicable.

The link destination object is selectable from an object list, in alternative to selecting directly one with the pen 2500 according to a user operation.

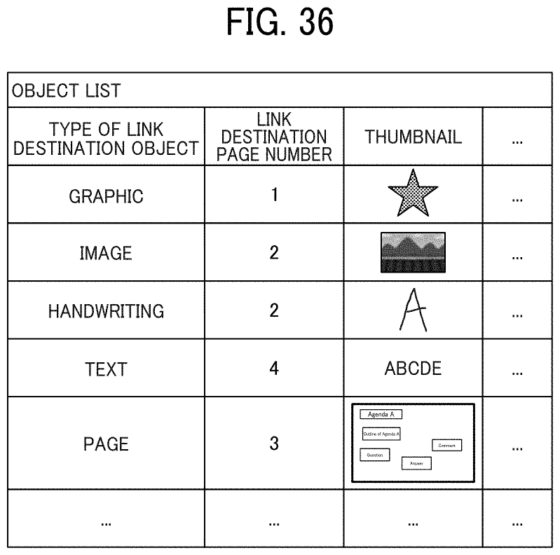

FIG. 36 is a diagram illustrating an object list to be displayed by the display control unit 24 according to the present embodiment. For example, when the user presses a link source object, the link generation unit 28 causes the display control unit 24 to display the object list.

The object list is a list generated based on the records in the object storage unit 41 indicated in Table 1. The object list may include thumbnails of objects. The user selects any desired object as a link destination from the object list. The link generation unit 28 receives the selected link destination object and sets the link destination object to Table 2 in the link storage unit 42 in association with the corresponding link source object.

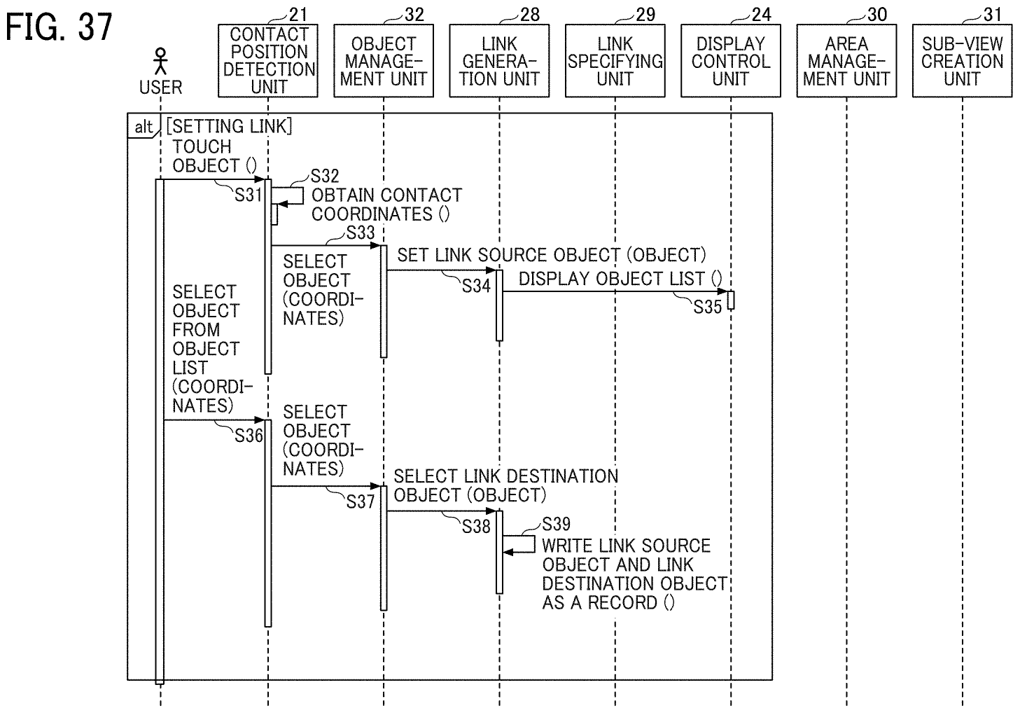

FIG. 37 is a sequence diagram illustrating a process of setting a link between two objects to be associated with each other performed by the display apparatus 2, according to the present embodiment.

S31 to S34: The processing is substantially the same as steps S1 to S4 in FIG. 20.

S35: The link generation unit 28 requests the display control unit 24 to display an object list.

S36: An object is selected from the object list according to a user operation. The contact position detection unit 21 receives coordinates.

S37: The contact position detection unit 21 requests the object management unit 32 to select an object corresponding to the coordinates by specifying the coordinates pressed according to a user operation.

S38: The object management unit 32 determines which row or line of object of the object list includes coordinates that is closest to, or same as, the coordinates pressed according to a user operation, and specifies a link destination object, accordingly. The object management unit 32 notifies the link generation unit 28 of an object ID of the object as the link destination object.

S39: The link generation unit 28 sets the link source object ID and the link destination object ID in the link storage unit 42.

As described above, the display apparatus 2 according to the present embodiment selects the link destination object from the object list according to a user operation, resulting in reducing time and effort of the user in performing operations for switching of display ranges and searching for the link destination object.

### Sixth Embodiment

Displaying Sub-View:

A description is given below of displaying a link destination by displaying a sub view according to a fifth embodiment. In the present embodiment, the hardware configuration illustrated in FIG. 9 and the functional configuration illustrated in FIG. 10 in the above-described embodiment are applicable.

According to the present embodiment, the display apparatus 2 does not switch the display range to the link destination object or the like, but displays the link destination object or the like in a sub-view section as a sub-view. This allows a user to check the link destination (the link destination object or the like) before the display range is switched. Note that the sub-view means displaying a display range different from the current display range. The display range as a sub-view may be referred to as a reduced display range. For example, the sub-view may be referred to as a thumbnail display or a pop-up display.

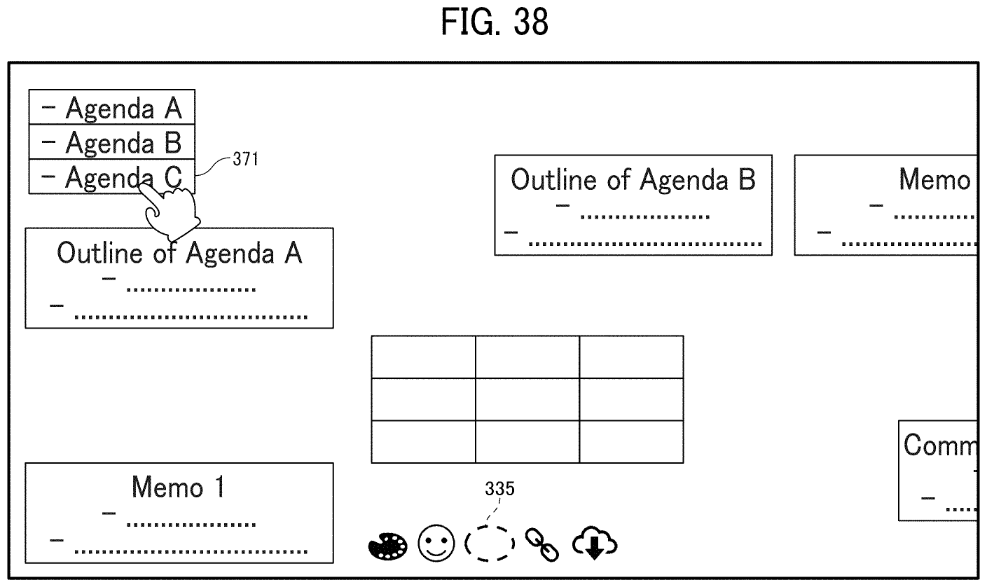

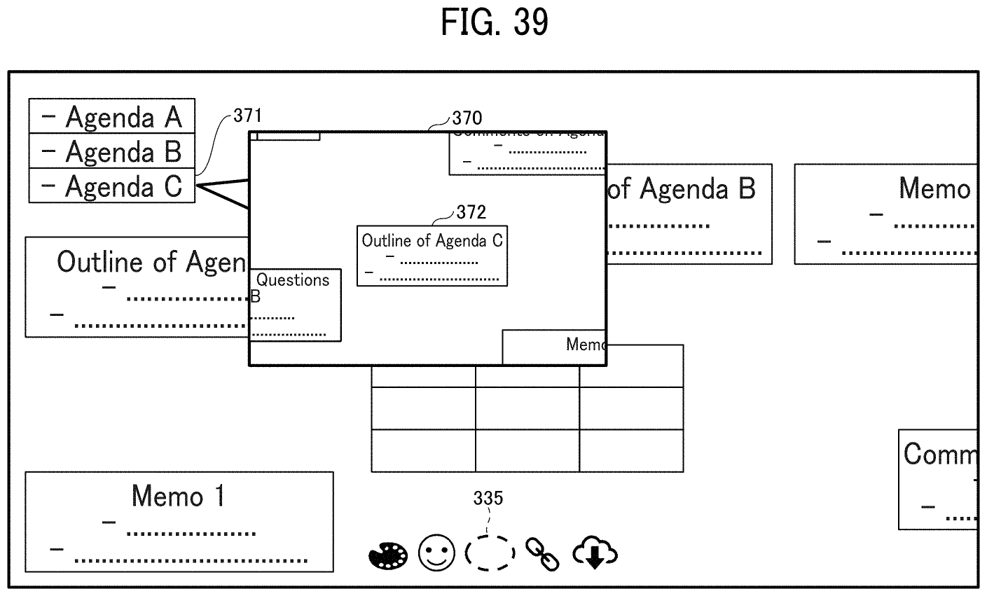

FIG. 38 is a diagram illustrating a screen on which a link source object 371 is being selected, according to the present embodiment. FIG. 39 is a diagram illustrating a screen including an example of a sub-view 370 that includes a link destination object 372 associated with the link source object 371 selected in FIG. 38. The sub-view 370 is displayed in proximity to the link source object 371. This allows the user to confirm the link destination object 372 without performing switching of display ranges.

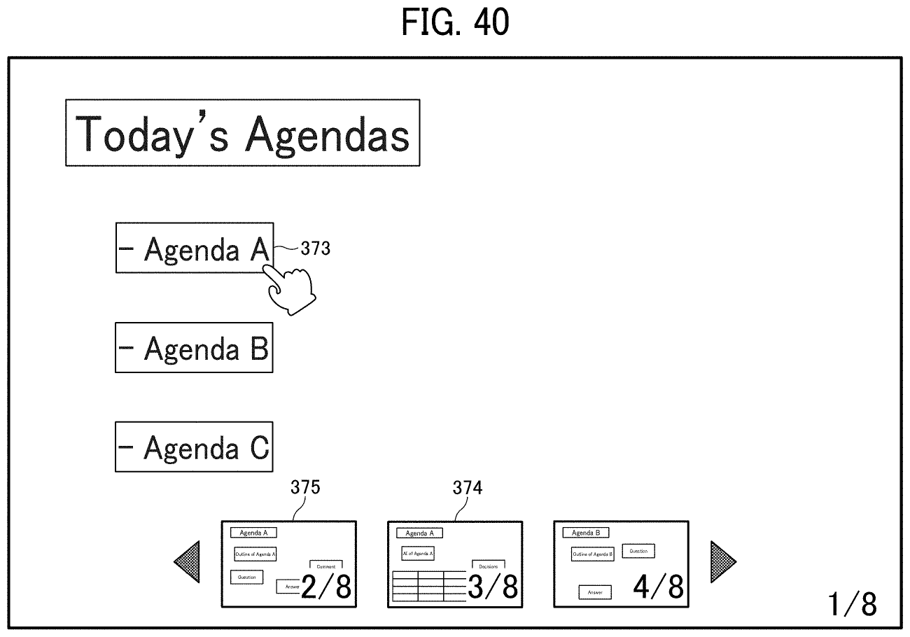

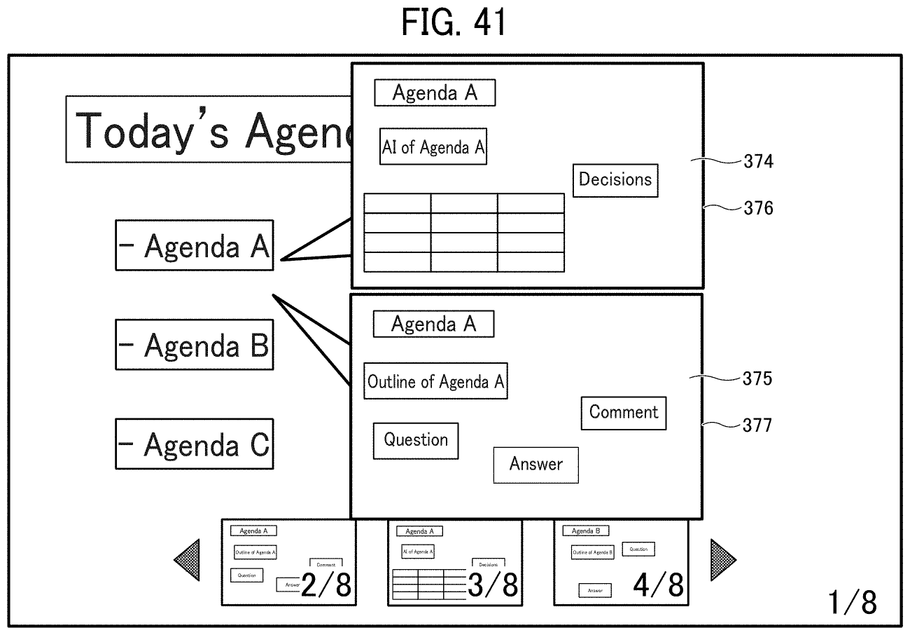

FIG. 40 and FIG. 41 are diagrams each illustrating a screen including a sub-view of which a corresponding type of link destination object is a page, according to the present embodiment. In the example of FIG. 40, a link source object 373 is selected by being pressed according to a user operation. Pages 374 and 375 displayed as thumbnails are associated with the link source object 373.

In FIG. 41, the two pages 374 and 375, which are link destination objects associated with the link source object 373, are displayed as sub-views 376 and 377. As described above, the display apparatus 2 displays all the link destination objects associated with the link source object 373 as the sub-views 376 and 377.

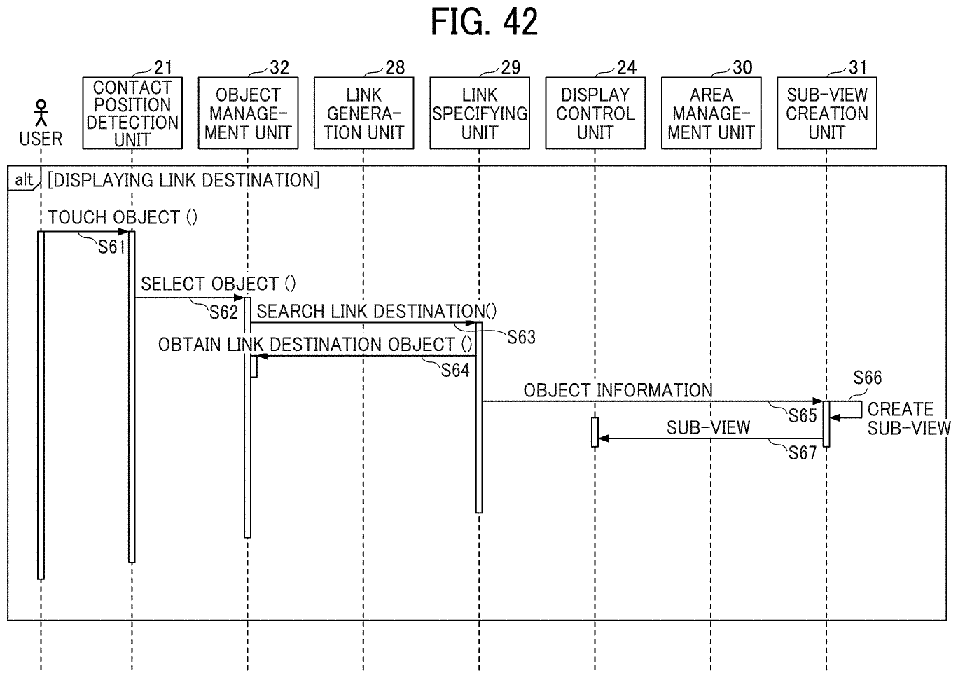

FIG. 42 is a sequence diagram illustrating a sequence diagram illustrating a process of displaying a sub-view, according to the present embodiment. In the description referring to FIG. 42, for simplicity only, the main differences from FIG. 26 are mainly described.

S61 to S64: The processing is substantially the same as steps S11 to S14 in FIG. 26.

S65: The link specifying unit 29 transmits object information of each link destination object to the sub-view creation unit 31.

S66: The sub-view creation unit 31 creates a thumbnail (sub-view) including the link destination object and surroundings of the link destination object based on the received object information.

S67: The sub-view creation unit 31 transmits the sub-view to the display control unit 24. The display control unit 24 displays the sub-view including the link destination object and surroundings of the link destination object in proximity to the link source object.

As described above, the display apparatus 2 according to the present embodiment displays the sub-view including the link destination object, and this allows the user to check the link destination before the display range is switched.

### Seventh Embodiment

Setting Link Destination by Making Reservation for Link Destination:

A description is given below of setting a link destination by making a reservation of the link destination according to a fifth embodiment. In the present embodiment, the hardware configuration illustrated in FIG. 9 and the functional configuration illustrated in FIG. 10 in the above-described embodiment are applicable.

There is a case in which the user using the display apparatus 2 desires to use an object as a link destination later while inputting the object by handwriting. To deal with this, such an object, which is to be a link destination, is set with object information, and when the user associates two objects, the link generation unit 28 accepts the link destination based on the object information.

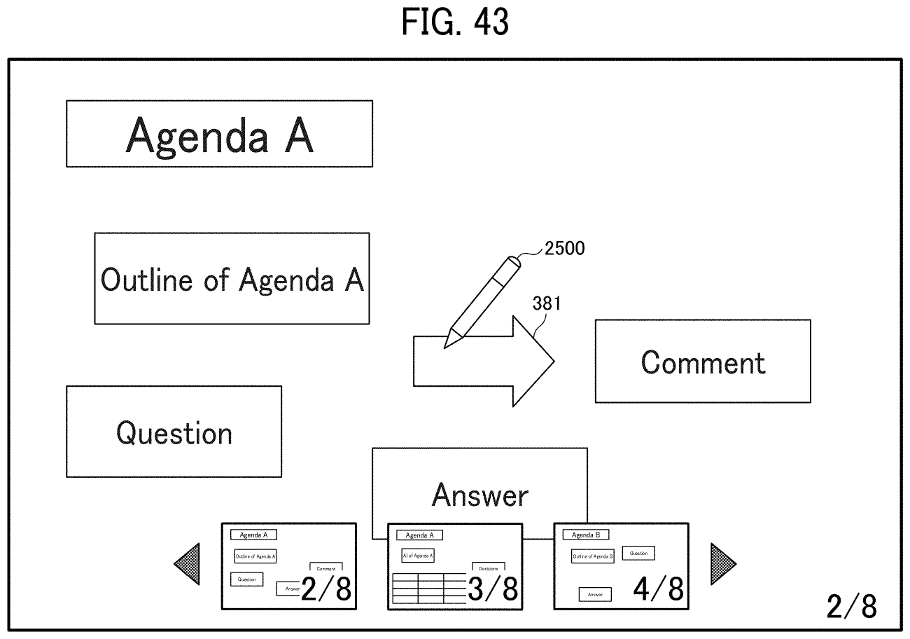

FIG. 43 is a diagram illustrating a screen on which a reservation for a link destination is being made, according to the present embodiment. First, the user selects an icon from the tool tray and switches the operation mode of the display apparatus 2 to a link destination list setting mode. In the link destination list setting mode, any desired object 381 is pressed according to a user operation.

The object management unit 32 registers that the object 381 has been reserved in the object information. Accordingly, the object storage unit 41 has items different from those in Table 1.

TABLE 3

| OBJECT | | | COOR- | | RE- | |
|---|---|---|---|---|---|---|
| ID | TYPE | PAGE | DINATES | SIZE | SERVED | . . . |
| 1 | HAND- | 1 | x1, y1 | W1, H1 | Fales | . . . |
| | WRITING | | | | | |
| 2 | TEXT | 1 | x2, y2 | W2, H2 | Fales | . . . |
| 3 | GRAPHIC | 1 | x3, y3 | W3, H3 | Fales | . . . |
| 4 | IMAGE | 2 | x4, y4 | W4, H4 | Fales | . . . |
| 5 | GRAPHIC | 3 | x5, y5 | W5, H5 | Fales | . . . |
| 6 | TEXT | 4 | x6, y6 | W6, H6 | Fales | . . . |
| 7 | IMAGE | 4 | x7, y7 | W7, H7 | Fales | . . . |
| 8 | GRAPHIC | 2 | X8, y8 | W8, H8 | True | |
| . . . | . . . | . . . | . . . | . . . | | . . . |

Table 3 schematically illustrates the link object information stored in the object storage unit 41. Table 3 in the object storage unit 41 has a data item of “RESERVED.” When the data item of “Reserved” indicates “True,” the object has been reserved as a link destination. With the data item of “RESERVED,” information indicating whether each object has been set as a link destination is stored. As indicated in Table 3, the data item of “RESERVED” of a record of an object ID of 8 is “True,” and this means an object having the object ID of 8 is reserved for a link destination.

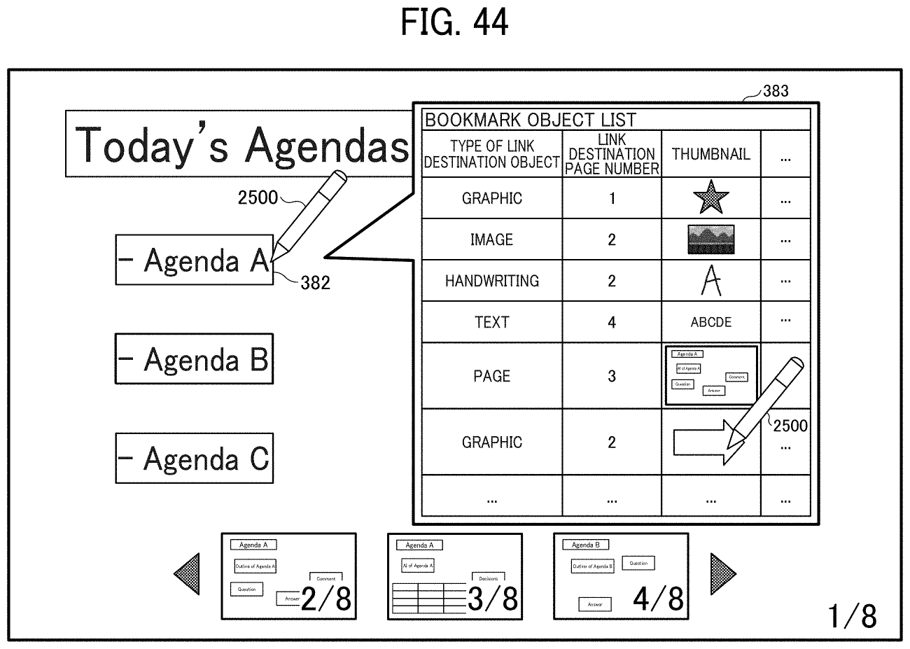

FIG. 44 is a diagram illustrating a screen displaying association of two objects by using reservations for a link destination, according to the present embodiment. When a link source object 382 is pressed according to a user operation, the display control unit 24 displays a reserved object list 383 on the screen. The reserved object list 383 is similar to the object list. The data item of “RESERVED” corresponding to each of the objects indicated in the reserved object list 383 has “True,” and this allows the user to easily select a reserved destination object.

When one of the objects is selected according to a user operation, the link generation unit 28 sets the link source object 382 and the link destination object selected by the user in the link storage unit 42 in association with each other.

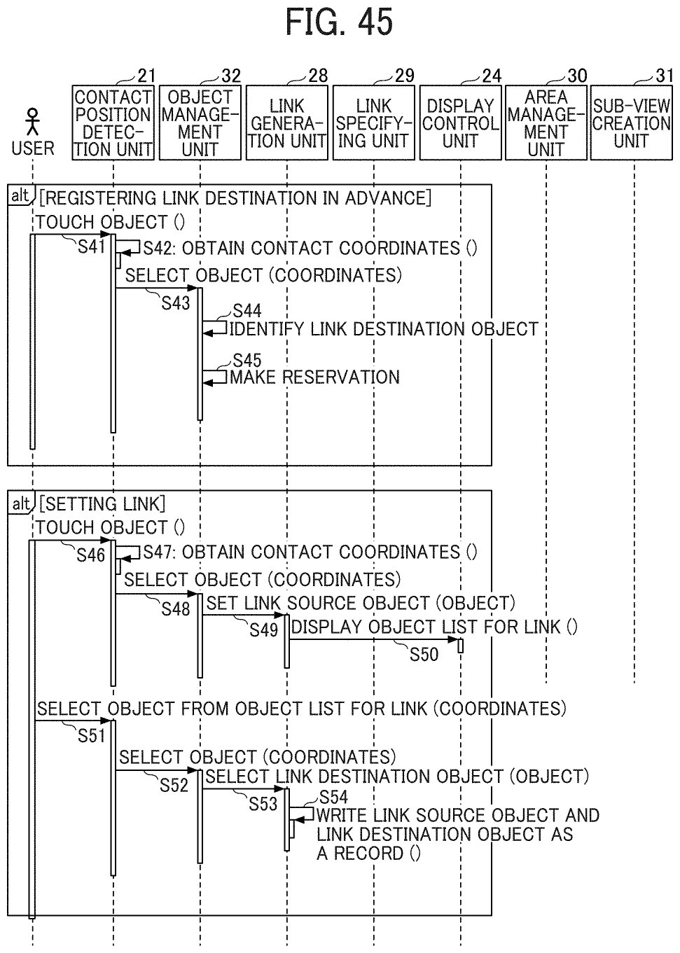

FIG. 45 is a sequence diagram illustrating a process of setting a link between two objects to be associated with each other by using a reserved object, according to the present embodiment.

A description is given below of a process of making a reservation for an object.

S41: In the link destination list setting mode, an object to be reserved is selected by being pressed according to a user operation.

S42: The contact position detection unit 21 detects coordinates pressed according to a user operation.

S43: The contact position detection unit 21 requests the object management unit 32 to select an object corresponding to the coordinates by specifying the coordinates pressed according to a user operation.

S44: The object management unit 32 searches the object storage unit 41 with the coordinates pressed according to a user operation, and specifies an object in the object storage unit 41.

S45: The object management unit 32 sets the data item of “RESERVED” of the object to “True.”

A description is given below of a process of setting a link.

S46 to S49: The processing is substantially the same as steps S1 to S4 in FIG. 20.

S50: The link generation unit 28 requests the display control unit 24 to display a reserved object list. The display control unit 24 acquires one or more objects of each of which the data item of “RESERVED” indicates “True” from the object information, and displays the one or more objects as the reserved object list.

S51: The user selects an object from the reserved object list. The contact position detection unit 21 receives coordinates.

S52: The contact position detection unit 21 requests the object management unit 32 to select an object corresponding to the coordinates by specifying the coordinates pressed according to a user operation.

S53: The object management unit 32 determines which row or line of object of the object list includes coordinates that is closest to, or same as, the coordinates pressed according to a user operation, and specifies a link destination object. The object management unit 32 notifies the link generation unit 28 of an object ID of the object as the link destination object.

S54: The link generation unit 28 sets the link source object ID and the link destination object ID in the link storage unit 42.

As described above, the display apparatus 2 displays reserved objects as a list, and this allows the user to easily select a link destination object in case that a page includes a large number of objects.

### Eighth Embodiment

Selecting and Displaying Link Destination:

A description is given below of jumping to a link destination by selecting the link destination to be displayed according to a sixth embodiment. In the present embodiment, the hardware configuration illustrated in FIG. 9 and the functional configuration illustrated in FIG. 10 described in the above embodiment are applicable.

There is a case in which a link source object is associated with a plurality of link destination objects. A description is given below of a method of selecting one of the plurality of link destination objects in such a case.

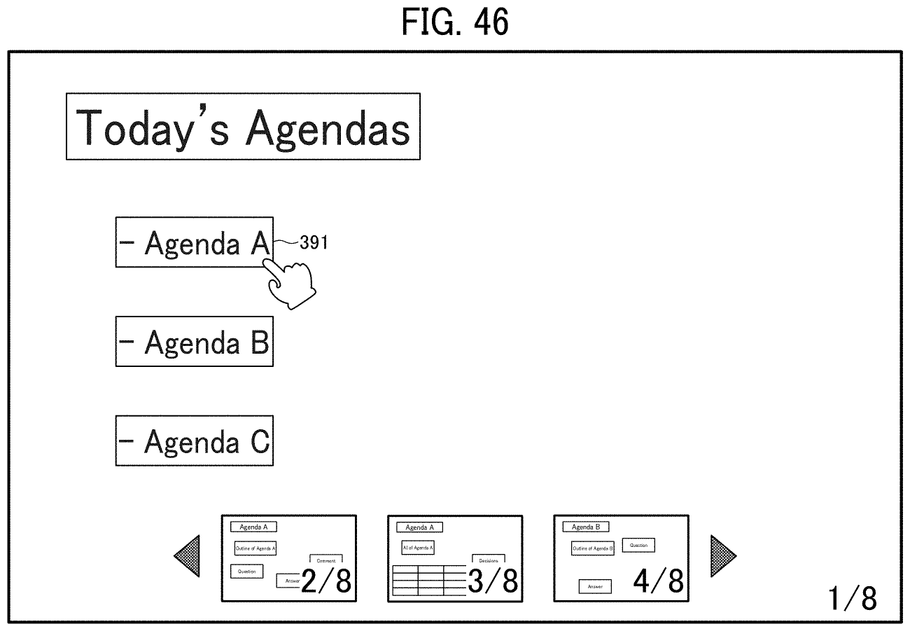

FIG. 46 is a diagram illustrating a screen on which a link source object 391 is pressed by a user, according to the present embodiment. A plurality of link destination objects are set to be associated with the link source object 391, which is pressed according to a user operation, in the link storage unit 42. When the link source object 391 to which the plurality of link destination objects are set is pressed, the link specifying unit 29 responds with a plurality of search results. The display control unit 24 presents the link destination objects corresponding to the search result to the user as a list.

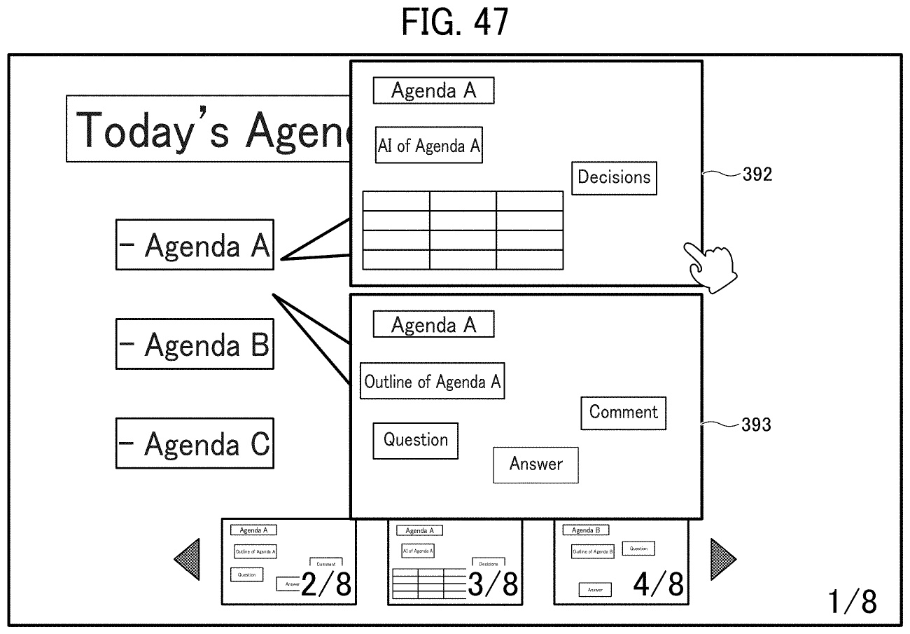

FIG. 47 is a diagram illustrating a screen on which thumbnails of link destination objects 392 and 393 are displayed, according to the present embodiment. In FIG. 47, the thumbnails of the two link destination objects 392 and 393 are displayed in proximity to the link source object. When one of the link destination objects 392 and 393 is pressed by a user, the link specifying unit 29 determines a display range in a manner that the display range includes the corresponding link destination object.

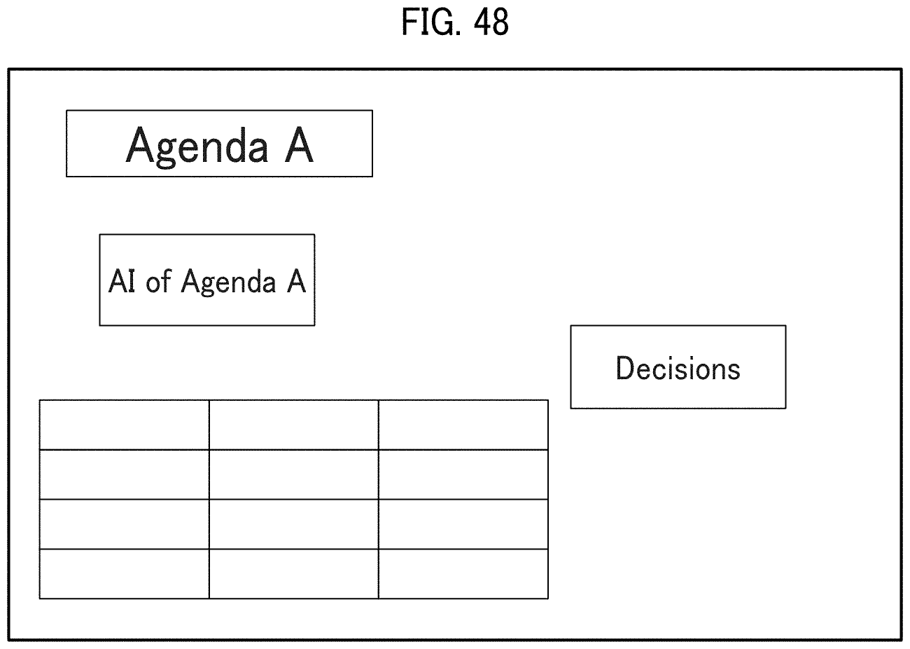

FIG. 48 is a diagram illustrating screen displaying a display range of the display apparatus 2 when the link destination object in FIG. 47 is selected. In the example of FIG. 48, the thumbnail of the link destination object 392 selected in FIG. 47 is the display range.

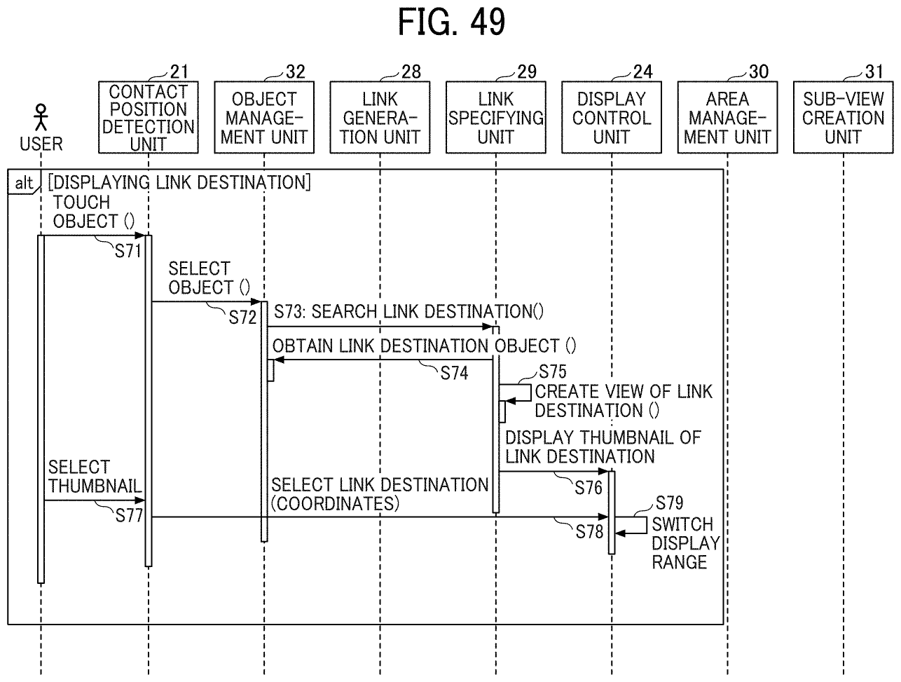

FIG. 49 is a sequence diagram illustrating a process, performed by the display apparatus 2, of displaying a link destination object that is selected according to a user operation from among a plurality of link destination objects displayed as thumbnails, according to the present embodiment.

S71 to S75: The processing is substantially the same as steps S11 to S15 in FIG. 26.

S76: The link specifying unit 29 requests the display control unit 24 to display a display range corresponding to the thumbnail created.

S77: The thumbnail to be specified as the display range is pressed according to a user operation.

S78: The contact position detection unit 21 notifies the display control unit 24 of the coordinates pressed according to a user operation.

S79: The display control unit 24 switches the display range to the thumbnail identified by the coordinates pressed according to a user operation.

As described above, when a plurality of link destination objects are associated with a link source object, the display range is switched to one corresponding to one of the plurality of link destination objects according to a user operation of selecting the one of the plurality of link destination objects.

### Ninth Embodiment

Preview Function and Next View Function:

A description is given below of switching a display range by using a preview function or a next view function according to a seventh embodiment. In the present embodiment, the hardware configuration illustrated in FIG. 9 and the functional configuration illustrated in FIG. 10 in the above-described embodiment are applicable.

There is a case in which a user desires to temporarily display a previous screen displaying a previous display range immediately after switching the display range to one corresponding to the link destination object. To deal with this, the preview function is known. In addition, when the user desires to display the link destination object again, the next view function, which is known, may be used.

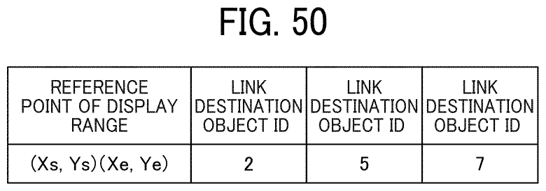

FIG. 50 is a diagram illustrating a table of time-series object list stored in the display control unit 24, according to the present embodiment. The time-series object list is a list in which a reference point of display range and one or more link destination objects are associated with each other in an order to be displayed. The reference point of display range indicates a display range displayed immediately before displaying the link destination object. The link destination object IDs corresponding to the reference point of display range indicates the link destination objects selected by the user and has been displayed by the display apparatus 2 in time series.

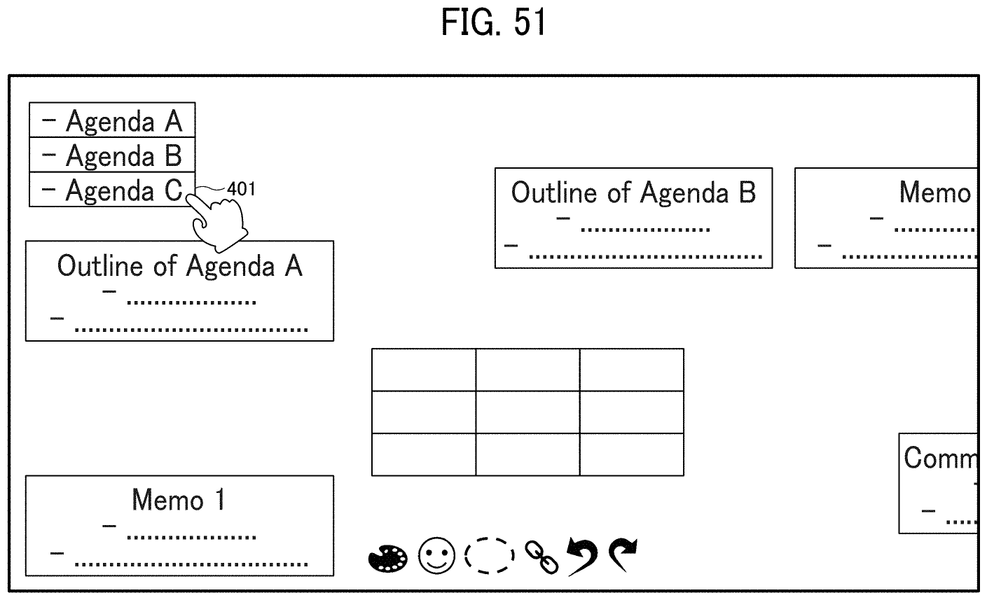

FIG. 51 is a diagram illustrating a screen on which an icon corresponding to a preview function is displayed, according to the present embodiment. On the screen illustrated in FIG. 51, a link source object 401 is pressed according to a user operation. The display control unit 24 stores a reference point of display range and a link destination object ID.

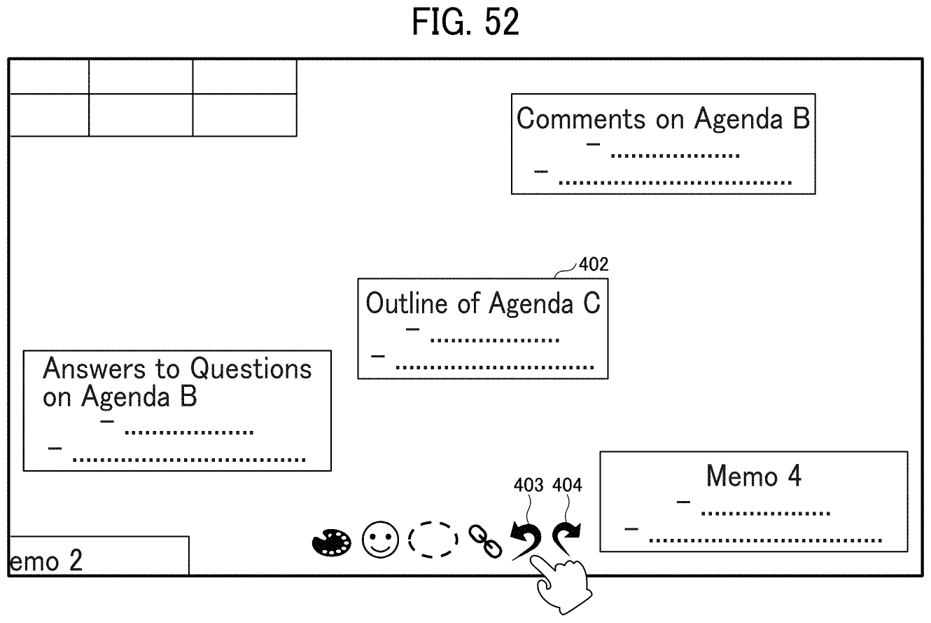

FIG. 52 is a diagram illustrating a screen including a link destination object 402 displayed by the display apparatus 2 when the link source object 401 is pressed, according to the present embodiment. A preview button 403 and a next button 404 are displayed on a tool tray as illustrated in FIG. 52. The preview button 403 is pressed according to a user operation. The display control unit 24 specifies a link destination object ID or a reference point of display range of a link destination object that is displayed immediately before a link destination object that is currently displayed, based on a link destination object ID of the link destination object that is currently displayed, and determines the display range corresponding to the specified link destination object ID or the specified reference point of display range.

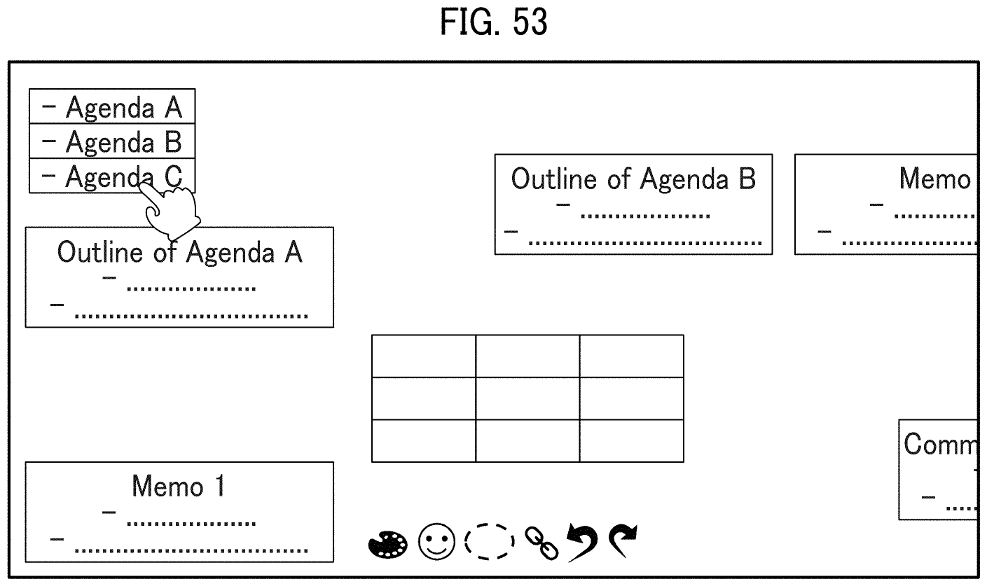

FIG. 53 is a diagram illustrating a screen that is displayed in response to the preview button 403 being pressed, according to the present embodiment. As described above, the link destination objects are displayed in a switchable manner, according to a user operation.

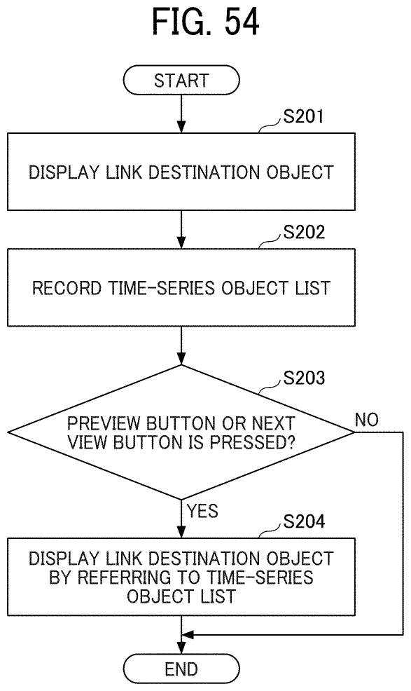

FIG. 54 is a flowchart illustrating a process of displaying a link destination object according to a user operation of selecting a preview function or a next view function, performed by the display apparatus 2 according to the present embodiment. The process illustrated in FIG. 54 starts in a state where the display apparatus 2 displays a link destination object.

The display control unit 24 displays a link destination object selected by the user (S201). In addition, the display control unit 24 creates a time-series object list in response to displaying the link destination object (S202).

The display control unit 24 determines whether a preview button or a next button is pressed (S203).

When the preview button or the next button is pressed, the display control unit 24 refers to the time-series object list and displays a corresponding link destination object (S204).

As described above, a previous display range that is displayed immediately before a current display range is displayed after temporarily displaying a link destination object corresponding to the current display range according to a user operation.

### Tenth Embodiment

A configuration of a display system, which performs one or more of the above-described processes, according to a tenth embodiment, will be described.

First Example of Configuration of Display System:

Although the display apparatus 2 according to the present embodiment is described as that having a large touch panel, the display apparatus 2 is not limited thereto. In one example, the display apparatus 2 may not be provided with the touch panel, but may be connected with the external touch panel to control display of the touch panel. In another example, the display apparatus 2 may operate in cooperation with an external server that stores various information to be used by the display apparatus 2.

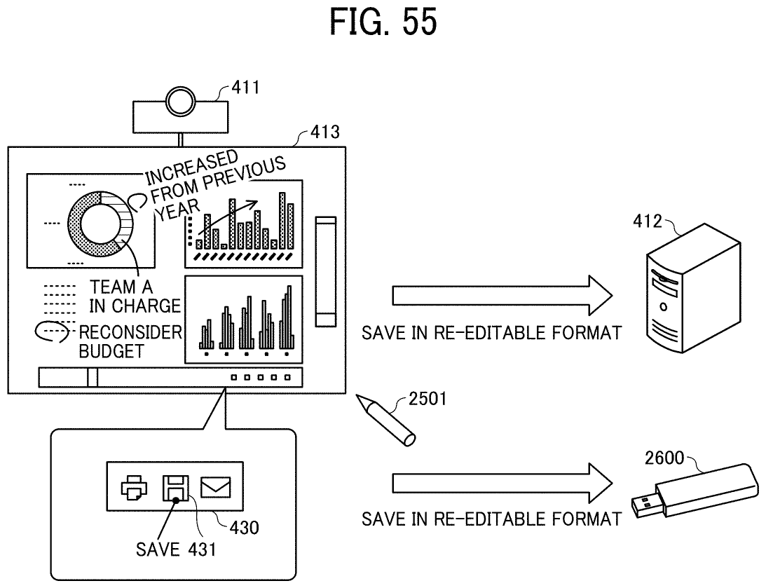

FIG. 55 is a diagram illustrating a configuration of a display system according to the present embodiment. The display system includes a projector 411, a whiteboard 413, and a server 412, and the projector 411 and the server 412 are communicably connected to each other via a network. In the example of FIG. 55, the projector 411 is installed on the upper face of the whiteboard 413, which is a general whiteboard (standard whiteboard). The projector 411 serves as the display apparatus 2 described above. In other words, the projector 411 is a general-purpose projector, but installed with software that causes the projector 411 to function as the each function of the display apparatus 2 as illustrated in FIG. 10. The server 412 or an external memory, such as a USB memory 2600, may serve as a function corresponding to the storage function (corresponding to storage unit 40) of the display apparatus 2. The “standard whiteboard” (the whiteboard 413) is not a flat panel display integral with a touch panel, but is a whiteboard to which a user directly handwrites information with a marker. Note that the whiteboard may be a blackboard, and may be simply a plane having an area large enough to project an image.

The projector 411 employs an ultra short-throw optical system and projects an image (video) with reduced distortion from a distance of about 10 cm to the whiteboard 413. This video may be transmitted from a PC connected wirelessly or by wire, or may be stored in the projector 411.

The user performs handwriting on the whiteboard 413 using a dedicated electronic pen 2501. The electronic pen 2501 includes a light-emitting element, for example, at a tip thereof. When a user presses the electronic pen 2501 against the whiteboard 413 for handwriting, a switch is turned on, and the light-emitting element emits light. The wavelength of light of the light-emitting element is near-infrared or infrared that is invisible to a user. The projector 411 includes a camera. The projector 411 captures, with the camera, an image of the light-emitting element, analyzes the image, and determines the direction of the electronic pen 2501. Thus, the contact position detection unit 21 (illustrated in FIG. 10), implemented by the camera, receives the light as the signal indicating that the electronic pen 2501 is pressed against the whiteboard 413. Further, the electronic pen 2501 emits a sound wave in addition to the light, and the projector 411 calculates a distance based on an arrival time of the sound wave. The projector 411 determines the position of the electronic pen 2501 based on the direction and the distance. Handwritten data is drawn (projected) at the position of the electronic pen 2501.

The projector 411 projects a menu 430. When the user presses a button of the menu 430 with the electronic pen 2501, the projector 411 determines the pressed button based on the position of the electronic pen 2501 and the ON signal of the switch. For example, when a save button 431 is pressed, handwritten data (coordinate point sequence) input by the user is saved in the projector 411. The projector 411 stores the handwritten information in a predetermined server 412, the USB memory 2600, for example. Handwritten information is stored for each page. Because being stored as coordinates instead of image data, the handwritten information is re-editable according to a user operation. However, in the present embodiment, an operation command can be called by handwriting, and the menu 430 does not have to be displayed.

### Eleventh Embodiment

Second Example of Configuration of Display System:

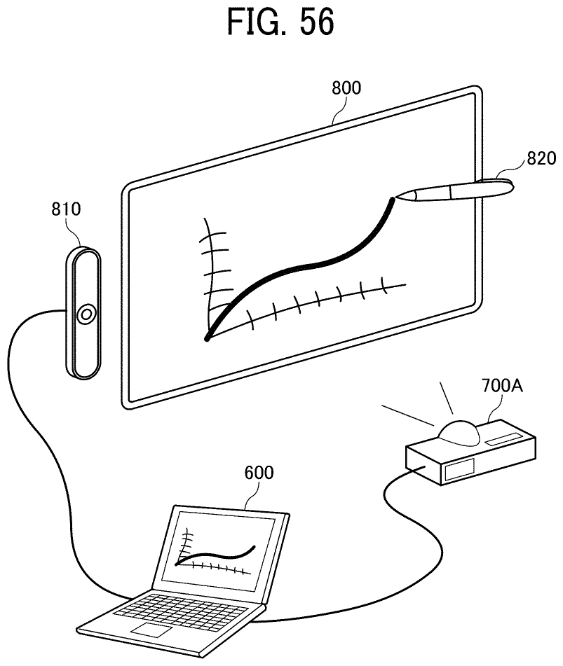

FIG. 56 is a diagram illustrating a configuration of a display system according to an eleventh embodiment. In the example of FIG. 56, the display system includes a terminal device 600, an image projection device 700A, and a pen motion detection device 810.

The terminal device 600 is coupled to the image projection device 700A and the pen motion detection device 810 by wire. The image projection device 700A projects image data input from the terminal device 600 onto a screen 800.

The pen motion detection device 810 communicates with an electronic pen 820 to detect a motion of the electronic pen 820 in the vicinity of the screen 800. More specifically, the pen motion detection device 810 detects coordinate information indicating a position pointed by the electronic pen 820 on the screen 800 and transmits the coordinate information to the device apparatus 600. The method of detecting is substantially the same as one described with reference to FIG. 55. A function corresponding to the contact position detection unit 21 (illustrated in FIG. 10) of the display apparatus 2, is implemented by the electronic pen 820 and the pen motion detection device 810. Other functions corresponding to the functional units other than the contact position detection unit 21 of the display apparatus 2 are implemented by the terminal device 600. In other words, the terminal device 600 is a general-purpose computer, and installed with software that causes the terminal device 600 to function as the function units, except for the contact position detection unit 21, of the display apparatus 2 as illustrated in FIG. 10. In addition, a function corresponding to the display control unit 24 is implemented by the terminal device 600 and the image projection device 700A.

Based on the coordinate information received from the pen motion detection device 810, the terminal device 600 generates image data (handwritten data) of handwriting input by the electronic pen 820 and causes the image projection device 700A to project the handwritten data on the screen 800.

The terminal device 600 generates data of a superimposed image in which an image based on handwritten data input by the electronic pen 820 is superimposed on the background image projected by the image projection device 700A.

### Twelfth Embodiment

Third Example of Configuration of Display System:

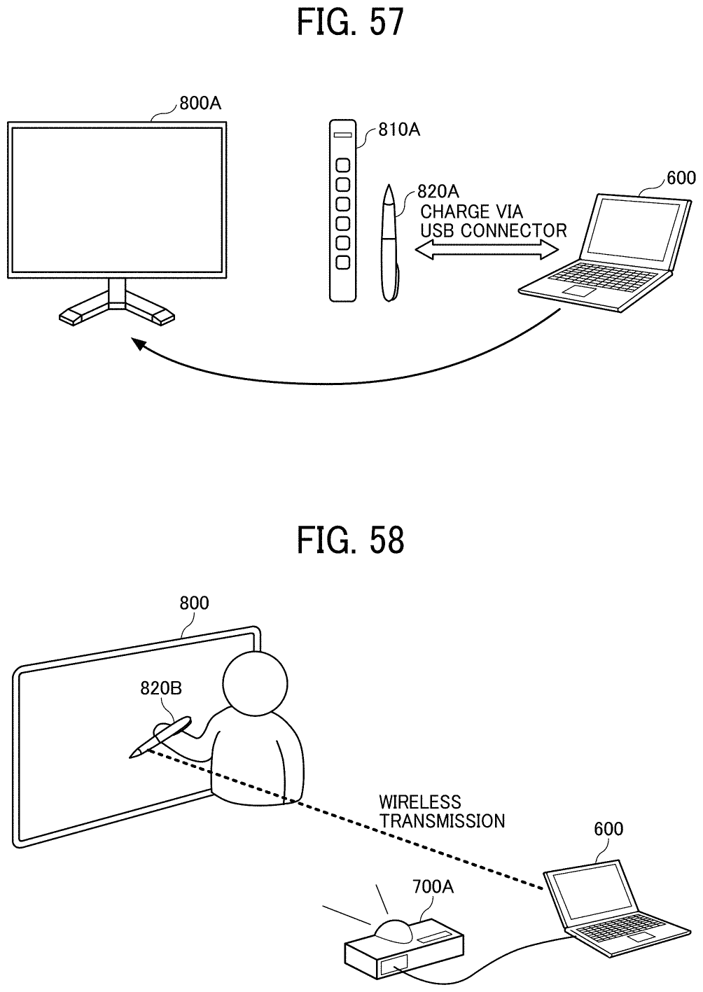

FIG. 57 is a diagram illustrating a configuration of a display system according to a twelfth embodiment. In the example of FIG. 57, the display system includes a terminal device 600, a display 800A, and a pen motion detection device 810A.

The pen motion detection device 810A, which is disposed in the vicinity of the display 800A, detects coordinate information indicating a position pointed by an electronic pen 820A on the display 800A and transmits the coordinate information to the terminal apparatus 600. The method of detecting is substantially the same as one described with reference to FIG. 55. In the example of FIG. 57, the electronic pen 820A can be charged from the terminal device 600 via a USB connector. A function corresponding to the contact position detection unit 21 (illustrated in FIG. 10) of the display apparatus 2, is implemented by the electronic pen 820A and the pen motion detection device 810A. Other functions corresponding to the functional units other than the contact position detection unit 21 of the display apparatus 2 are implemented by the terminal device 600. In other words, the terminal device 600 is a general-purpose computer, and installed with software that causes the terminal device 600 to function as the function units, except for the contact position detection unit 21, of the display apparatus 2 as illustrated in FIG. 10. In addition, a function corresponding to the display control unit 24 is implemented by the terminal device 600 and the display 800A.

Based on the coordinate information received from the pen motion detection device 810, the terminal device 600 generates image data (handwritten data) of handwriting input by the electronic pen 820A and displays an image based on the image data of handwriting on the display 800A.

### Thirteenth Embodiment

Fourth Example of Configuration of Display System:

FIG. 58 is a diagram illustrating a configuration of a display system according to a thirteenth embodiment. In the example illustrated in FIG. 58, the display system includes a terminal device 600 and an image projection device 700A.

The terminal device 600 communicates with an electronic pen 820B through by wireless communication such as BLUETOOTH, to receive coordinate information indicating a position pointed by the electronic pen 820B on a screen 800. The electronic pen 820B may read minute position information on the screen 800, or receive the coordinate information from the screen 800.

Based on the received coordinate information, the terminal device 600 generates image data (handwritten data) of handwriting input by the electronic pen 820B, and causes the image projection device 700A to project an image based on the handwritten data.

The terminal device 600 generates data of a superimposed image in which an image based on the handwritten data input by the electronic pen 820B is superimposed on the background image projected by the image projection device 700A. A function corresponding to the contact position detection unit 21 (illustrated in FIG. 10) of the display apparatus 2, is implemented by the electronic pen 820B and the terminal device 600. Other functions corresponding to the functional units other than the contact position detection unit 21 of the display apparatus 2 are implemented by the terminal device 600. In other words, the terminal device 600 is a general-purpose computer, and installed with software that causes the terminal device 600 to function as the function units of the display apparatus 2 as illustrated in FIG. 10. In addition, a function corresponding to the display control unit 24 is implemented by the terminal device 600 and the image projection device 700A.

The embodiments described above are applied to various system configurations.

Variation:

The above-described embodiment is illustrative and does not limit the present disclosure. Thus, numerous additional modifications and variations are possible in light of the above teachings within the scope of the present disclosure. For example, elements and/or features of different illustrative embodiments may be combined with each other and/or substituted for each other within the scope of the present invention. Any one of the above-described operations may be performed in various other ways, for example, in an order different from the one described above.

The character string is stored as a character code, and the handwritten data is stored as coordinate point data by the display apparatus 2. Further, the program may be stored in various storage media or in storage on a network, and may be downloaded by the display apparatus 2 for use. The display apparatus 2 may be changed to any display device such as a general information processing device, for use at a different time. This allows a user to continue a conference or the like by reproducing the handwritten content on different display apparatuses 2.

Further, in the description of some of the embodiments given above, an electronic whiteboard is used as an example of the display apparatus 2, but this is not limiting. A device having a substantially the same functions as the electronic whiteboard may be referred to as an electronic information board, an interactive board, or the like. The present disclosure is applicable to any information processing apparatus with a touch panel.

Examples of the information processing apparatus with a touch panel include, but not limited to, a projector (PJ), a data output device such as a digital signage, a head up display (HUD), an industrial machine, an imaging device such as a digital camera, a sound collecting device, a medical device, a network home appliance, a notebook PC, a mobile phone, a smartphone, a tablet terminal, a game machine, a personal digital assistant (PDA), a wearable PC, and a desktop PC.

Further, in the embodiments described above, the display apparatus 2 detects the coordinates of the pen tip of the pen with the touch panel. However, the display apparatus 2 may detect the coordinates of the pen tip using ultrasonic waves. Further, the pen transmits ultrasonic waves together with light emission, and the display apparatus 2 calculates a distance based on an arrival time of the ultrasonic waves. The position of the pen can be identified by the direction and the distance. The projector draws (projects) the trajectory of the pen as stroke data.

In addition, the functional configuration as illustrated in FIG. 10 is divided into the blocks based on main functions of the display apparatus 2, in order to facilitate understanding the processes performed by the display apparatus 2. Each processing unit or each specific name of the processing unit is not to limit a scope of the present disclosure. A process implemented by the display apparatus 2 may be divided into a larger number of processes depending on the content of process. Also, one processing unit may be divided so as to include more processes.

A part of the processing performed by the display apparatus 2 may be performed by a server connected to the display apparatus 2 via a network. For example, the object storage unit 41 and the link storage unit 42 may be provided at a memory outside the display apparatus 2.

Each of the functions of the described embodiments may be implemented by one or more processing circuits. Processing circuitry includes a programmed processor, as a processor includes circuitry. A processing circuit also includes devices such as an Application Specific Integrated Circuit (ASIC), a Digital Signal Processor (DSP), a Field Programmable Gate Array (FPGA), and conventional circuit components arranged to perform the recited functions.

Further, in the present embodiment, even if a threshold value is exemplified as a comparison, the threshold value is not limited to the exemplified value. For this reason, in the present embodiment, regarding all of the threshold values, expressions “less than the threshold value” and “equal to or less than the threshold value” have an equivalent meaning, and expressions “greater than the threshold value” and “equal to or more than the threshold value” have an equivalent meaning. For example, the expression “less than the threshold value” when the threshold value is 11” has the same meaning as “less than or equal to the threshold value when the threshold value is 10.” In addition, the expression “exceeding the threshold value” when the threshold value is 10 has the same meaning as the expression “equal to or greater than the threshold value” when the threshold value is 11.

The object management unit 32 is an example of a reception unit. The link generation unit 28 is an example of a setting unit. The display control unit 24 is an example of a display control unit. The operation receiving unit 27 is an example of an operation receiving unit. The area management unit 30 is an example of an area receiving unit.

With a related art, a link is not settable between objects by a user.

A display apparatus according to an embodiment of the present disclosure, a link is settable between objects to be associated with each other according to a user operation.

A display apparatus according to an embodiment of the present disclosure, a link is settable between objects according to a user operation in order to associate the two objects with each other.

1. A display apparatus, comprising
circuitry configured to:
display, on a display, a plurality of objects including a first object and a second object, one or more of the plurality of objects reflecting handwriting input;
receive a first selection of the first object;
receive a second selection of the second object; and
set a link between the first object and the second object to associate the first object and the second object with each other.

2. The display apparatus of claim 1, wherein
the circuitry
displays, on the display, an icon used to launch a link setting function,
receives an operation of selecting the icon,
receives the first selection of the first object based on first coordinates at which a first input is received on the display, and
receives the second selection of the second object based on second coordinates at which a second input is received on the display.

3. The display apparatus of claim 2, wherein,
based on a determination that the second coordinates represent an area having a size equal to or greater than a threshold, the circuitry determines, as the second object, the area represented by the second coordinates.

4. The display apparatus of claim 1, wherein
the circuitry displays, on the display, an object list stored in a memory in response to receiving the first selection of the first object based on first coordinates at which a first input is received on the display, and
determines, as the second object, a particular object selected from the object list.

5. The display apparatus of claim 4, wherein
the object list stored in the memory includes a reserved object list corresponding to a plurality of reserved objects, each of the plurality of reserved objects is reserved to be the second object,
the circuitry displays, on the display, the reserved object list in response to receiving the first selection of the first object based on the first coordinates, and the second object is selected from the reserved object list.

6. The display apparatus of claim 1, wherein,
in response to receiving an input of coordinates after setting the link, the circuitry identifies the first object based on the coordinates, and displays, on the display, a display range including the second object associated with the first object.

7. The display apparatus of claim 6, wherein,
in case that a part of the second object is to be out of the display range of the display, the circuitry changes a display scale factor according to one of width and height of the second object to display the second object to be fit in, the one of the width and the height being larger than the other one of the width and the height.

8. The display apparatus of claim 6, wherein,
in case that the second object includes a character string, the circuitry determines which one of right to left and the left to the right the character string is written,
based on a first determination that the character string is written from the right to the left, the circuitry displays the second object on an upper right in the display range, and
based on a second determination that the character string is written from the left to the right, the circuitry displays the second object on an upper left in the display range.

9. The display apparatus of claim 6, wherein,
the circuitry reduces a size of the display range including the second object to generate a reduced display range and displays the reduced display range in proximity to the first object.

10. The display apparatus of claim 9, wherein,
the second object includes a plurality of second objects and the display range includes a plurality of display ranges each of which includes a corresponding one of the plurality of second objects, and
the circuitry
reduces the plurality of display ranges to generate a plurality of reduced display ranges and displays the plurality of reduced display ranges in proximity to the first object, and
displays one of the plurality of display range in response to a user operation of selecting a corresponding one of the plurality of reduced display range.

11. The display apparatus of claim 6, wherein
the second object includes a plurality of second objects, and
the circuitry displays each of the plurality of second objects one by one and records identification information of each of the plurality of second objects in time series corresponding to a displaying order as a time-series object list, and
in response to an operation of selection of one of a preview button and a next button, the circuitry changes the display range based on the time-series object list.

12. The display apparatus of claim 1, further comprising:
a memory that stores link information associating the first object and the second object.

13. The display apparatus of claim 1, wherein
the object represents at least one of a character string, a graphical representation, an image, or a partial area or entire page of a plurality of pages.

14. A display method, comprising:
displaying, on a display, a plurality of objects including a first object and a second object, one or more of the plurality of objects reflecting handwriting input;
receiving a first selection of the first object:
receiving a second selection of the second object; and
setting a link between the first object and the second object to associate the first object and the second object with each other.

15. A non-transitory recording medium storing a plurality of instructions which, when executed by one or more processors, causes the processors to perform a method, comprising:
displaying, on a display, a plurality of objects including a first object and a second object, one or more of the plurality of objects reflecting handwriting input:
receiving a first selection of the first object;
receiving a second selection of the second object; and
setting a link between the first object and the second object to associate the first object and the second object with each other.
